(19) United States
(12) Patent Application Publication
(10) Pub. No.: US 2009/0070858 A1
(43) Pub. Date: Mar. 12, 2009

(54) AUTHENTICATION COMPUTER AND PROGRAM

(75) Inventors: Shin Hiraide, Tokyo (JP); Masamichi Takahashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KEYTEL CO., LTD., Tokyo (JP)

(21) Appl. No.: 12/299,533

(22) PCT Filed: May 1, 2007
(86) PCT No.: PCT/JP2007/059297

§ 371 Date: Nov. 4, 2008

(30) Foreign Application Priority Data
May 10, 2006 (JP) 2006-131063
Nov. 8, 2006 (JP) 2006-302222
Feb. 28, 2007 (JP) 2007-048603

(51) Int. Cl. H04L 9/32

(52) U.S. Cl. 726/4

(57) ABSTRACT

By utilizing representative embodiment of present invention, the security and convenient of personal authentication system are enhanced. An authentication computer comprising a processor, a memory and an interface: wherein the memory memorizes an user information; wherein the processor receives an authentication demand; wherein the processor allocates, to the received authentication demand, an e-mail address which hasn't been allocated to any authentication demand; wherein the processor receives an e-mail; wherein the processor receives an authentication result demand; wherein the processor specifies the authentication demand corresponded to the received authentication result demand; wherein the processor specifies a source e-mail address from the e-mail where a destination e-mail address is the e-mail address allocated to the specified authentication demand; wherein the processor refers to the user information to specify the user corresponded to the specified source e-mail address; and wherein the processor sends data corresponded to the specified user to the client computer.

### TECHNICAL FIELD

The present invention is relation among an authentication system and an authentication computer and a program.

### BACKGROUND ART

So far, the method using combination of user ID and passwords, in the case of user identification and service provision, have been known as method of personal authentication. For example, some who logs in displayed web sites through a operational personal computer by way of the Internet, enters both of user ID and passwords and sends authentication demand to an authentication server. Also, in the case of withdrawing own deposit from the ATM of the financial institution, the user inserts the cash card to the ATM, enters the personal code number and sends the authentication demand to the authentication server. In this case, user ID is cash card.

However, the user of web site take the trouble about entering the user ID and the passwords corresponding to the display of the web site. Furthermore, method of this authentication is used widely in the Internet banking or the web site of the various electronic commercial dealings. For this, the both of password and user ID that some should administrate have been increasing. If the users of web site forget the user ID or password, they need to inquiry the ID and password for administrator of the site and can't receive the convenience of the web site. Also, the illegal use and transaction by the stolen user ID and passwords has increasing and troubling in the public, recently. The fishing fraud and the spy ware soft are known in general, as a meaning of snatching of user ID and password. The fishing fraud is the actions of setting the imitational site which resemble a legal web site, letting the right user enter both the user ID and the password and snatching both this user ID and password. Also, the spy ware is the software installed without noticing about this installation and reads the various user ID and the password entered from right user, informs the read things to the server of wiretapper by the way of the Internet. Suppose the trade is approved by such the illegal Internet banking and the illegal electronic commercial dealings, both the right user and the web site administrator would suffer the immense damage related losing of the trust of the site and the issue of compensate.

In the case of the user withdrawing own deposits at ATM of financial institution, need to trouble inserting cash card and entering the personal code number. Because of being stolen cash card and personal code number by the machine of filming a person without his knowledge and permission, this results in leading illegal withdrawing user deposits. Both of the right user and the bank would suffer the immense damage related losing of the trust of the site and the issue of compensate.

JP 2002-229951 A refers to method of personal authentication for user in the case of permit to authenticate by entering user ID and password to the web site, and dialing the particular telephone number.

JP 2004-213440 A refers to method of personal authentication for user in the case of permit to authenticate by using the telephone number as a user ID and entering this number to the web site, dialing the particular telephone number.

### DISCLOSURE OF THE INVENTION

### Problems to be Solved by the Invention

According to the method disclosed in JP 2002-229951 A, in order to utilizing the particular telephone number of the sender, the method can prevent pretender from pretending as a right user even though user ID and password are stolen from the right user. Also, according to the method disclosed in JP 2004-213440 A, in order to utilizing the particular telephone number of the sender, the art can prevent pretender from pretending as a right user even though pretending telephone number are entered in the web site. However, the utilizing these methods disclosed in JP 2002-229951 A and JP 2004-213440 A can't authenticate in the case of the user being incapable of dialing with caller ID. In some case, for example, beyond a radio wave reach, these methods can't authenticate.

Furthermore, the utilizing these methods disclosed in JP 2002-229951 A and JP 2004-213440 A can't specify exactly the corresponding relation with the user sending dial with caller ID and the computer operated by this user. For this, the utilizing these methods disclosed in JP 2002-229951 A and JP 2004-213440 A can't provide highly secure and convenient authentication. For example, in the utilizing these methods disclosed in JP 2002-229951 A and JP 2004-213440 A, there is some possibility of pretending as a right user by doing some trials that enter user ID and so on of right user's over and over again by the illegal pretender. Concretely, after the right user performed the authentication by dialing the particular telephone number, if redialing was achieved by accident, the outsider being not the right user was authenticated as a right user.

This invention considered problem listed above these method provides highly secure and convenient personal authentication system.

### Means for Solving the Problems

According to an exemplary embodiment of this invention, there is provided an authentication computer comprising a processor, a memory and an interface: wherein the authentication computer is coupled to plural client computers via a network; wherein the memory memorizes an user information which includes a correspondence relation between an user and an e-mail address of the user; wherein the processor receives an authentication demand from the client computer; wherein the processor allocates, to the received authentication demand, an e-mail address which hasn't been allocated to any authentication demand among the e-mail addresses for the authentication computer to receive an e-mail; wherein the processor receives an e-mail; wherein the processor receives an authentication result demand from the client computer; wherein the processor specifies the authentication demand corresponded to the received authentication result demand; wherein the processor specifies a source e-mail address from the e-mail where a destination e-mail address is the e-mail address allocated to the specified authentication demand; wherein the processor refers to the user information to specify the user corresponded to the specified source e-mail address; and wherein the processor sends data corresponded to the specified user to the client computer which sent the received authentication result demand.

By utilizing representative embodiment of present invention, the security and convenient of personal authentication system are enhanced.

### BEST MODE FOR CARRYING OUT THE INVENTION

An embodiment of present invention was described referred to some figures.

### First Embodiment

FIG. 1 shows a compositional outline figure about a personal authentication system of the first embodiment. The personal authentication system displayed FIG. 1 was equipped with plural client computers 10 and an e-mail authentication computer 3. The client computer 10 is operated by user trying to be authenticated and connected by a network 9. The client computer 10 was described in FIG. 2 in detail. Also, the network 9 is a data communications network such as an exclusive network, a public exchangeable telephone circuit network, a LAN and the like. Also, the network 9 doesn't matter whether being an internal network or being the Internet. The e-mail authentication computer 3 is connected to the client computer 10 via the network 9. Concretely, the e-mail authentication computer 3 is connected to the client computer 10 via the Internet or the internal network. Also, the e-mail authentication computer 3 doesn't matter whether being equipped with an interface for the Internet or for the internal network. In this case, the e-mail authentication computer 3 is connected to some client computer 10 via the Internet, moreover, to some of other client computer 10 via the internal network. The e-mail authentication computer 3 is described in FIG. 3 in detail. Also, to clear about description, the authentication processing for the single client computer 10 of the personal authentication system in the first embodiment is described. Actually, the e-mail authentication computer 3 performs authentication for plural client computers 10 via the network 9. In short, the e-mail authentication computer 3 can receive an authentication result demand from plural client computers 10. Also, in FIG. 1, double client computers 10 were showed, but need not decide the number of client computer 10 in regard to the personal authentication system.

FIG. 2 shows structural block figure of the client computer 10 equipped with the personal authentication system of the first embodiment. Physically, the client computer 10 is a computer system equipped with a sending/receiving device 11, a central processing device 12, a main storage device 13, an auxiliary storage device 14, input device (being omitted representation) and display device (being omitted representation) and the like. The sending/receiving device 11 is an interface sending and receiving data to/from the outer device (the e-mail authentication computer 3) and connected to the network 9. The central processing device 12 is, for example, a CPU. The central processing device 12 performs each processing by carrying out program memorized in the main memory device 13. The main storage device 13 is, for example, a memory. The main storage device 13 is memorized data and the like needed by the central processing device 12 and programs executed by the central processing device 12. The auxiliary storage device 14 is, for example, a hard disk. The auxiliary storage device 14 memorizes all kinds of information. The input device is, for example, a mouse, a keyboard or a touch panel. All kinds of information are input by user to the input device. The display device is display. The information indicated display from central processing device 12 is displayed in display device. Also, the client computer 10 doesn't matter whether any form as long as it is equipped with the sending/receiving device 11, the central processing device 12 and the main memory device 13. For example, the client computer 10 is the personal computer, the server, the cellular phone or ATM and so on.

FIG. 3 is the block diagram of the composition of the e-mail authentication computer 3 that the personal authentication system of the first embodiment is equipped with. The e-mail authentication computer 3 is physically the computer system which is equipped with a sending/receiving device 31, a central processing device 32, a main storage device 33, an auxiliary storage device 34, an input device (the being omitted representation), the display device (the being omitted representation) and so on. Incidentally, the IP address to receive e-mail and domain (DOMAIN) are allocated for the e-mail authentication computer 3. The sending/receiving device 31 is connected with network 9 and is an interface which sends and receives a device outside (the client computer 10) and a data. For example, central processing device 32 is a CPU. Central processing device 32 processes variously by executing the program which is memorized in the main storage device 33. For example, the main storage device 33 is a memory. As for the main storage device 33, the program which is executed by central processing device 32 and the information which is needed by central processing device 32 and so on are memorized. For example, the auxiliary storage device 34 is a hard disk. The auxiliary storage device 34 memorize s various information. For example, the input device is a mouse, a key board or a touch panel. All the kind of information is inputted into input device from the administrator. The display device is a display. The information which was instructed to displaying from central processing device 32 is displayed in the display. Incidentally, the e-mail authentication computer 3 may be whatever form as long as it is equipped with the sending/receiving device 31, central processing device 32 and the main storage device 33. For example, the e-mail authentication computer 3 is a personal computer or a server and so on.

FIG. 4 is the functional block diagram of the e-mail authentication computer 3 of the first embodiment. The authentication program 300 of the first embodiment is memorized in the auxiliary storage device 34 of the e-mail authentication computer 3. When the authentication program 300 of the first embodiment is executed, in the main storage device 33 of the e-mail authentication computer 3, it is a main module 331, an authentication demand reception module 3321, an authentication result demand reception module 3322, an authentication demand ID generation module 333, an authentication e-mail address generation module 334, an authentication e-mail address sending module 335, an e-mail reception module 336, a receipted e-mail reading module 337, an authentication module 338 and an authentication result sending module 339 are memorized.

The main module 331 unifies the whole processing of the e-mail authentication computer 3.

The authentication demand reception module 3321 receives an authentication demand from the client computer 10.

The authentication result demand reception module 3322 receives an authentication result demand from the client computer 10.

The authentication demand ID generation module 333 generates an authentication demand ID. Then, the authentication demand ID generation module 333 allocates the generated authentication demand ID for the authentication demand which was received by the authentication demand reception module 3321. The authentication demand ID is the unique identifier of the authentication demand. When the e-mail authentication computer 3 receives the authentication demand temporarily from the plural client computers 10 at the same time, it allocates the different authentication demand ID for the each received authentication demand. Also, the e-mail authentication computer 3 may receive the second authentication demand from the client computer from 10 which is the sender of the first authentication demand during concerned processing while the e-mail authentication computer 3 is processing the first authentication demand. In this case, the e-mail authentication computer 3 allocates the authentication demand ID which is different from the first authentication demand for the second authentication demand. With this, the e-mail authentication computer 3 can process plural authentication demands which are sent from the identical client computer 10 at the same time. The authentication demand ID generation module 333 generates the authentication demand ID based on a random number, a generation time of the application ID and the authentication demand ID and the like. Incidentally, the application ID is the unique identifier of the authentication program 300 which is preinstalled in concerned the e-mail authentication computer 3. Incidentally, the application ID is generally known as the license key and omitted a explanation in detail. Incidentally, the generation-method of the authentication demand ID may use the other way as far as it achieves the purpose.

The authentication e-mail address generation module 334 produces newly the e-mail address for the e-mail authentication computer 3 to receive e-mail. Then, the authentication e-mail address generation module 334 allocates the produced e-mail address for the authentication demand ID which was generated by the authentication demand ID generation module 333 as the authentication e-mail address. For this, the relation between the authentication e-mail address and the authentication demand ID becomes 1-1. That is, the authentication demand is uniquely specified by the authentication e-mail address. Incidentally, when fixed time passes after the authentication e-mail address generation module 334 allocates the authentication e-mail address for the authentication demand ID, it may cancel the allocation of the authentication e-mail address. Also, the authentication e-mail address generation module 334 may cancel the allocation of the authentication e-mail address to the concerned authentication demand in the other opportunity which contains the completion of the authentication for the authentication demand and the like. When canceling the allocation of the authentication e-mail address for the authentication demand, the identity theft using the authentication e-mail address passes away. For example, the time of the cancellation of the allocation of the authentication e-mail address may be a time behind the constant time after doing allotting such as 10-minute later. In regard to the time of the cancellation of the allocation of the authentication e-mail address, therefore, it is entrusted by the embodiment person of the present invention.

The specific way of canceling the allocation of the authentication e-mail address for the authentication demand here is described. For example, the authentication e-mail address to try to cancel is annulled by the authentication e-mail address generation module 334. Once the authentication e-mail address is annulled, the e-mail authentication computer 3 can not receive e-mail with the concerned authentication e-mail address. Moreover, the authentication e-mail address generation module 334 chooses the record that the authentication e-mail address to try to cancel matches with the authentication e-mail address 3412 of the authentication e-mail address mapping table 341 from the authentication e-mail address mapping table 341. Then, the authentication e-mail address generation module 334 deletes a chosen record from the authentication e-mail address mapping table 341. The way of canceling the allocation of the authentication e-mail address to the authentication demand may be any other way as far as it is possible to achieve the purpose. Incidentally, at the authentication e-mail address mapping table 341 (FIG. 5), therefore, it is mentioned in detail later.

Next, one of the examples of the generation-method of the e-mail address of the authentication e-mail address generation module 334 is described. The authentication e-mail address generation module 334 produces the authentication e-mail address based on the authentication demand ID and the domain which is allocated for the e-mail authentication computer 3. In the case of the authentication demand ID being “0029382” and moreover the domain being “authadd.com”, the authentication e-mail address generation module 334 generates “0029382@authadd.com” as the authentication e-mail address. Because the authentication demand ID is unique, the authentication e-mail address, too, becomes unique. Incidentally, the generation-method of the authentication e-mail address doesn't have to use always authentication demand ID if the relation between the authentication e-mail address and the authentication demand ID is 1-1. The generation-method of the authentication e-mail address may use the other way as far as it achieves the purpose.

FIG. 5 is the schematic of the authentication e-mail address mapping table 341 which is memorized in the auxiliary storage device 34 of the e-mail authentication computer 3 of the first embodiment. The authentication e-mail address mapping table 341 includes an authentication demand ID3411, an authentication e-mail address 3412 and an user e-mail address 3413. The authentication demand ID3411 is the unique identifier of the authentication demand. The authentication e-mail address 3412 is the e-mail address which was allocated for the authentication demand which is identified by authentication demand ID3411 of the concerned record. The user e-mail address 3413 is the e-mail address of the user who demands an authentication. Incidentally, in this embodiment, the e-mail address of the user is used as the unique identifier of the user, too.

It returns to FIG. 4. Incidentally, the authentication e-mail address allocation module may be memorized instead of the authentication e-mail address generation module 334 at the main storage device 33 of the e-mail authentication computer 3. In this case, the plural e-mail addresses for the e-mail authentication computer 3 to receive e-mail is beforehand set to the e-mail authentication computer 3. As for the authentication e-mail address allocation module, the e-mail authentication computer 3 specifies an e-mail address to neither with the authentication demand ID which was generated before from the inside of the e-mail address for the e-mail authentication computer 3 to receive e-mail. Then, the authentication e-mail address allocation module allocates the specified e-mail address for the authentication demand ID generated by authentication demand ID generation module 333 as the authentication e-mail address. That is, the authentication e-mail address allocation module doesn't allot the authentication e-mail address which is already allocated for the authentication demand ID to the other authentication demand. In this case, too, the relation between the authentication e-mail address and the authentication demand ID becomes 1-1. That is, the authentication demand is uniquely specified by the authentication e-mail address. But, the authentication e-mail address allocation module must cancel the allocation of the authentication e-mail address to the authentication demand ID. It is because the e-mail address which is allocated for the authentication demand ID has been lacking. For example, the authentication e-mail address allocation module cancels the allocation of the authentication e-mail address when the fixed time passes after it allocates an authentication e-mail address. Also, the authentication e-mail address allocation module cancels the allocation of the authentication e-mail address to the concerned authentication demand when it completes an authentication to the authentication demand. Then, the authentication e-mail address allocation module can allocate the e-mail address that an allocation was canceled once again for the different authentication demand ID as the authentication e-mail address. But, the e-mail authentication computer 3 can not authenticate a lot of users in the fixed time more than the number of the beforehand set e-mail addresses. Because, when all of the e-mail addresses for the e-mail authentication computer 3 to receive e-mail have already allocated for the authentication demand ID, the authentication e-mail address allocation module can not be allocated for the authentication demand ID which was generated newly. That only a number according to the offer scale of the service beforehand set therefore about the e-mail address for the e-mail authentication computer 3 to receive e-mail 3 is desirable. Incidentally, because the specific way of canceling the allocation of the authentication e-mail address to the authentication demand by the authentication e-mail address allocation module is same as the authentication e-mail address generation module 334, an explanation about this is omitted.

The authentication e-mail address sending module 335 sends the authentication e-mail address which was generated by the authentication e-mail address generation module 334 and the authentication demand ID which was generated by authentication demand ID generation module 333 to the client computer 10.

The e-mail reception module 336 receives e-mail from the client computer 10. Incidentally, the e-mail reception module 336 may receive e-mail from the apparatus except the client computer 10.

The receipted e-mail reading module 337 acquires a source e-mail address and a destination e-mail address from the e-mail which the e-mail reception module 336 received.

The authentication module 338 performs the authentication of the user who operates the client computer 10 based on an user management table 342 (FIG. 6).

FIG. 6 is the schematic of the user management table 342 which is memorized in the auxiliary storage device 34 of the e-mail authentication computer 3 of the first embodiment. The user management table 342 includes an user ID 3421 and an e-mail address 3422. The user ID 3421 is the unique identifier of the user who is authenticated by the e-mail authentication computer 3 of the first embodiment. The e-mail address 3422 is the e-mail address of the user who is identified by the user ID 3421 of the concerned record. Generally, e-mail address 3422 is the e-mail address that only the user who is identified by the user ID 3421 of the concerned record is usable. In the e-mail, because private contents are contained, a lot of individuals possess the e-mail address of one's own. Incidentally, user management table 342 may includes the other information which is peculiar to the user. For example, the peculiar information of the user includes at least one out of the user name, the password, the credit card number, the cash card number, the biological information of the user, the schedule table, the operation record and the balance of the user. In other words, at user management table 342, the peculiar information of the user matches to user ID 3421 and is managed.

The user of the e-mail authentication computer 3 of the first embodiment registers the user ID 3421 and the e-mail address 3422 to the user management table 342 beforehand in fixed way. Incidentally, when the e-mail address 3422 is used as the user ID, the user ID 3421 can be omitted.

The authentication result sending module 339 sends an authentication result judged by the authentication module 338 to the client computer 10.

Next, the processing of the individual authentication way of the first embodiment is described using FIG. 7. FIG. 7 is the sequence chart of the processing of the individual authentication way of the first embodiment.

The client computer 10 sends the authentication demand to the e-mail authentication computer 3 via the network 9 as a start of the user operation (ST111).

The e-mail authentication computer 3 receives the authentication demand from the client computer 10 (ST112). Then, the e-mail authentication computer 3 generates the authentication demand ID (ST113). Next, the e-mail authentication computer 3 produces an authentication e-mail address (ST114). Next, the e-mail authentication computer 3 generates a new record in the authentication e-mail address mapping table 341. Next, the e-mail authentication computer 3 memorizes the generated authentication demand ID in the authentication demand ID 3411 of the newly created record. Next, the e-mail authentication computer 3 memorizes the generated authentication e-mail address in the authentication e-mail address 3412 of the newly created record (ST115). In other words, after the generated authentication demand ID to the generated authentication e-mail address is matched, it is memorized by the e-mail authentication computer 3.

Next, the e-mail authentication computer 3 sends the generated authentication e-mail address and the generated authentication demand ID to the client computer 10 via the network 9 (ST116).

The client computer 10 receives the authentication e-mail address and the authentication demand ID from the e-mail authentication computer 3 (ST117).

The client computer 10 sends the e-mail of which destination e-mail address is the received authentication e-mail address via the network 9 as a start of the user operation (ST118).

Then, the e-mail authentication computer 3 receives e-mail from the client computer 10 (ST119). Next, a source e-mail address and a destination e-mail address is acquired from the received e-mail by the e-mail authentication computer 3. Next, the e-mail authentication computer 3 cancel the authentication e-mail address which matches with the acquired destination e-mail address. At this time, as for the e-mail authentication computer 3, it may judge whether the acquired source e-mail address was camouflaged or not. Then, only when the acquired source e-mail address is judged not to be camouflaged, the e-mail authentication computer 3 carries out the following processing. Incidentally, the camouflage of the acquired source e-mail address may be judged in any way.

Next, a source e-mail address and a destination e-mail address are acquired from the received e-mail by the e-mail authentication computer 3. Next, the e-mail authentication computer 3 chooses a record where the authentication e-mail address 3412 of the authentication e-mail address mapping table 341 matches the acquired destination e-mail address from the authentication e-mail address mapping table 341. Next, the e-mail authentication computer 3 memorizes the acquired source e-mail address in the user e-mail address 3413 of the chosen record (ST120).

On the other hand, the client computer 10 sends the authentication result demand which contains the authentication demand ID to the e-mail authentication computer 3 via the network 9 (ST121). Incidentally, the client computer 10 may send the authentication result demand as a start of the user operation and the authentication result demand every constant time.

Then, the e-mail authentication computer 3 receives the authentication result demand from the client computer 10 (ST122). Next, the authentication demand ID is acquired from the received authentication result demand by the e-mail authentication computer 3. Next, the e-mail authentication computer 3 chooses a record where authentication demand ID3411 of the authentication e-mail address mapping table 341 matches the acquired authentication demand ID from the authentication e-mail address mapping table 341. Continuously, the e-mail authentication computer 3 extracts the user e-mail address 3413 from the chosen record. Incidentally, when the user e-mail address 3413 can not be extracted, it judges authentication to be impossible by the e-mail authentication computer 3. On the other hand, the e-mail authentication computer 3 chooses a record where the e-mail address 3422 of the user management table 342 (FIG. 6) matches the extracted user e-mail address 3413 from the user management table 342 (ST123). When the matched record can not be chosen from user management table 342, the e-mail authentication computer 3 judges as authentication to be impossible. Incidentally, in the first embodiment, the e-mail authentication computer 3 judges authentication to be impossible about the user who isn't beforehand registered to user management table 342. However, the e-mail authentication computer 3 may authenticate the user who isn't beforehand registered to user management table 342 as the new user. In this case, the e-mail authentication computer 3 generates a new user ID when the mail address can not be extracted a matched record from user management table 342. Then, so as not to overlap all user IDs 3421 which are contained in user management table 342 at this time, the e-mail authentication computer 3 generates a user ID. Next, the e-mail authentication computer 3 generates a new record in the user management table 342. Next, the e-mail authentication computer 3 memorizes the newly generated user ID in the user ID 3421 of the newly generated record. Moreover, the e-mail authentication computer 3 memorizes the extracted user e-mail address 3413 in the e-mail address 3422 of the newly generated record. With this, the e-mail authentication computer 3 memorizes in the user management table 342 after the generated user ID and the source e-mail address which is acquired from the e-mail are matched by the e-mail authentication computer 3. Then, the e-mail authentication computer 3 authenticates the user corresponding to the source e-mail address which is acquired from the e-mail as the new user. Incidentally, the e-mail authentication computer 3 may receive the peculiar information of the registered user from the client computer 10. Then, the e-mail authentication computer 3 memorizes the received peculiar information of the user in the newly generated record. Incidentally, the peculiar information of the user may be contained in the authentication demand, may be contained in the authentication result demand and may be independently sent.

On the other hand, when the matched record can be choose, the e-mail authentication computer 3 judges authentication to be possible. With this, the e-mail authentication computer 3 can specify the publisher of the authentication demand. Specifically, the e-mail authentication computer 3 extracts the user ID 3421 from the chosen record. Then, the e-mail authentication computer 3 specifies that the publisher of the authentication demand which is identified by the acquired authentication demand ID is an identified user by the extracted user ID 3421.

Next, the e-mail authentication computer 3 sends an authentication result to the client computer 10 via the network 9 (ST124). Incidentally, the e-mail authentication computer 3 may send the peculiar information of the user corresponding to the extracted user ID 3421 to the client computer 10 with the authentication result.

Then, the client computer 10 receives the authentication result from the e-mail authentication computer 3 (ST125).

As above-mentioned, the user of the client computer 10 can be authenticated without entering a user ID and a password. Therefore, there is no danger that a user ID and a password are snatched. Also, the user of the client computer 10 doesn't have to manage a user ID and a password. In this way, this embodiment makes the management of the user ID and the password by the user of the client computer 10 unnecessary. Also, the labor which the user inputs the user ID and the password can be omitted. Moreover, the danger that the user ID and a password are snatched passes away. In other words, the individual authentication system in this embodiment can safely and conveniently authenticate a user.

In this embodiment, the e-mail authentication computer 3 is supposed to be composed of one piece of computer but depending on the scale of the service to be provided and so on, it may be composed of more than one piece of computer. Also, the e-mail authentication computer 3 may be functionally composed of more than one piece of computer. In these cases, the computer which composes the e-mail authentication computer 3 is each other connected through the suitable data transfer line.

Here, a maximum characteristic in this embodiment is described. As above-mentioned, the client computer 10 sends the e-mail to the e-mail address to authenticate. Then, the e-mail authentication computer 3 receives the e-mail. The e-mail authentication computer 3 specifies the user who tries to be authenticated based on the source e-mail address of the received e-mail. Also, the e-mail authentication computer 3 specifies the authentication demand ID which is the unique identifier of the authentication demand based on the source e-mail address of the received e-mail. In other words, the e-mail authentication computer 3 can specify the correspondence of the authentication demand and the user who demands an authentication by the concerned authentication demand. Next, the client computer 10 sends an authentication result demand to the e-mail authentication computer 3. Then, the e-mail authentication computer 3 receives the authentication result demand. The e-mail authentication computer 3 specifies the correspondence of the authentication result demand and the authentication demand based on the authentication demand ID which is contained in the received authentication result demand. Therefore, the e-mail authentication computer 3 can specify the client computer 10 which is operated by the user. With this, in this embodiment, the e-mail authentication computer 3 can realize an authentication though the user ID isn't contained in the authentication demand.

Also, in this embodiment, the e-mail authentication computer 3 sends the generated authentication e-mail address and the authentication demand ID to the client computer 10 but may send only the authentication e-mail address to the client computer 10. In this case, the authentication demand ID3411 of the authentication e-mail address mapping table 341 and the authentication demand ID generation module 333 can be omitted. In other words, the authentication e-mail address is used as the identifier to identify the authentication demand, too. Then, the client computer 10 sends the authentication result demand which contains the authentication e-mail address instead of the authentication demand ID to the e-mail authentication computer 3. Then, the authentication e-mail address is acquired with the authentication result demand by the authentication module 338. Next, the authentication module 338 chooses a record where the authentication e-mail address 3412 of the authentication address mapping table 341 matches the acquired authentication e-mail address from the authentication e-mail address mapping table 341. Then, the authentication module 338 extracts the user e-mail address 3413 from the chosen record. In the same way, it may be used as the identifier for the part of the authentication e-mail address to identify the authentication demand.

Also, in this embodiment, the client computer 10 sends the e-mail to the received authentication e-mail address after it received the authentication e-mail address from the e-mail authentication computer 3. However, it may be as follows. The client computer 10 displays the authentication e-mail address which was received from the e-mail authentication computer 3. Next, the user may send the e-mail to the authentication e-mail address from a second client computer 10 different from the client computer 10 which is displaying the authentication e-mail address. The user who is authenticated in this case is the user corresponding to the source e-mail address of the e-mail which was sent from the second client computer 10. Then, the client computer 10 which displayed the authentication e-mail address receives the authentication result from the e-mail authentication computer 3. For example, the client computer 10 which displays the authentication e-mail address is a personal computer, and the second client computer 10 which sends to the email is the cell phone connected by the Internet and which is possible to send e-mail.

By the way, in the above-mentioned embodiment, the user of the client computer 10 uses e-mail to be authenticated. The user of the client computer 10 may use the communication of SIP (Session Initiation Protocol) to receive an authentication. In this case, the client computer 10 is equipped with a function of the SIP user agent. Also, the e-mail authentication computer 3 is equipped with the function of the SIP user agent and the function of the SIP server. Then, the e-mail authentication computer 3 generates the authentication user agent address instead of the authentication e-mail address. The authentication user agent address is the address for the e-mail authentication computer 3 to receive the communication which is based on SIP. The address system does the omission of the detailed explanation of the purpose like the e-mail. The generation-method of the authentication user agent address is good if it is same as the generation-method of the authentication e-mail address. After the generated authentication demand ID and the generated authentication user agent address are matched by the e-mail authentication computer 3, these are memorized in the authentication e-mail address mapping table. The client computer 10 sends a signaling to the authentication user agent address with SIP as a start of the user operation. The e-mail authentication computer 3 receives the signaling from the client computer 10. The e-mail authentication computer 3 extracts the source user agent address and a destination user agent address from the received signaling. Next, from the authentication e-mail address mapping table, the e-mail authentication computer 3 chooses a record where the user agent address of the authentication e-mail address mapping table matches the acquired destination user agent address from the authentication e-mail address mapping table. Next, the e-mail authentication computer 3 memorizes the extracted user agent address of the user in the chosen record. By this, the e-mail authentication computer 3 memorizes the correspondence of the extracted user agent address and the authentication demand ID in the authentication e-mail address mapping table. On the other hand, the client computer 10 sends the authentication result demand which contains authentication demand ID to the e-mail authentication computer 3. The e-mail authentication computer 3 receives the authentication result demand from the client computer 10. The e-mail authentication computer 3 extracts the authentication demand ID from the received authentication result demand. Next, the e-mail authentication computer 3 chooses a record where the authentication demand ID of the authentication e-mail address mapping table matches the extracted authentication demand ID from the authentication e-mail address mapping table. Next, the e-mail authentication computer 3 extracts the user agent address of the user from the chosen record. It judges whether or not the e-mail authentication computer 3 could extract the user agent address of the user from the user management table here. When it is possible to extract, it judges that the authentication of the e-mail authentication computer 3 is be possible. Then, the e-mail authentication computer 3 can specify the publisher of the authentication demand. Specifically, the e-mail authentication computer 3 extracts the user ID from the chosen record. Then, the e-mail authentication computer 3 specifies that the publisher of the authentication demand identified by the extracted authentication demand ID is the user which is identified by the extracted user ID. Incidentally, the e-mail authentication computer 3 may include the peculiar information of the user corresponded to the extracted user ID in the authentication result. Incidentally, as for all embodiments, instead of the e-mail, it may use the communication by the SIP.

Here, the transformation example of the first embodiment of the present invention is described. When the e-mail authentication computer 3 of the first embodiment receives the authentication result demand from the client computer 10, it confirmed whether or not the user e-mail address 3413 extracted from the authentication e-mail address mapping table 341 is memorized in user management table 342. However, as for the e-mail authentication computer 3, it may confirm whether or not the source e-mail address of the received e-mail is memorized in user management table 342 when receiving e-mail. In this case, the authentication e-mail address mapping table 341 includes a confirmation result flag. The confirmation result flag shows whether or not it was confirmed with the e-mail authentication computer 3 in the memory of the source e-mail address of the e-mail in the user management table 342. Specifically, “0” of the default value is beforehand memorized in the confirmation result flag. Then, the e-mail authentication computer 3 memorizes “1” in the confirmation result flag when confirming that the source e-mail address of the received e-mail is memorized in user management table 342. Then, when the e-mail authentication computer 3 receives the authentication result demand from the client computer 10, instead of referring to the user management table 342, it refers to the authentication e-mail address mapping table 341. When “1” is specifically memorized in the confirmation result flag of the authentication e-mail address mapping table 341, it judges the authentication of the e-mail authentication computer 3 to be possible. On the other hand, when “0” is memorized in the confirmation result flag of the authentication e-mail address mapping table 341, it judges the authentication of the e-mail authentication computer 3 to be impossible.

By the way, because the safety of this invention depends on the strength to the camouflage of the e-mail, I describe about the camouflage of the e-mail.

First, the case where the source e-mail address of the e-mail is camouflaged is described. if the camouflager camouflages the source e-mail address of the e-mail and is authenticated with the e-mail authentication computer 3 of the first embodiment, he can pretend the original user who possesses the camouflaged e-mail address Therefore, the e-mail authentication computer 3 has the e-mail receiver function according to SPF (Sender Policy Framework). The SPF is the technology for the e-mail server to detect the camouflage e-mail. The e-mail authentication computer 3 requires inquiry to a DNS (Domain Name Server) about the domain of the received e-mail. Then, it judges whether the source e-mail address of the e-mail is camouflaged with checking off an inquiry result by DNS and the source IP address of the e-mail by the e-mail authentication computer 3. Incidentally, the camouflage e-mail detection technology which the e-mail authentication computer 3 adopts may be the other way as far as it achieves the purpose.

Next, the case where the destination e-mail address of the e-mail was camouflaged is described. By camouflaging the destination e-mail address of the e-mail, even if it is authenticated with the e-mail authentication computer 3 of the first embodiment, the camouflager can not pretend others. Rather, the others become the camouflager. The others who become the camouflager are the person who operates the client computer received the e-mail address which is identical with the camouflaged destination e-mail address as the authentication e-mail address. Therefore, the camouflager can not make a profit even if he camouflages the destination e-mail address of the e-mail. Also, matching the camouflaged e-mail address for the authentication e-mail address to be generated by the random number and so on with the authentication e-mail address is rare.

This place describes an authentication in this invention. The authentication in this invention includes an authentication with the wide meaning in addition to the general concept. Specifically, it is the verification whether or not the user has the right for using the service which is provided by the individual authentication system with the authentication in this invention. The individual authentication system of this invention can provide the service which matches every user who identified Therefore, the authentication demand in this invention is the demand of the verification whether or not the user has the right for using the service which is provided by the individual authentication system. For example, the authentication demand is the demand of the log-in of the WEB page. In this case, the e-mail authentication computer 3 may be the WEB server and may be an authentication dedicated-computer which receives the authentication demand from the WEB server. Also, the authentication demand is the demand of the credit card transaction in the WEB page. In this case, the e-mail authentication computer 3 may be the WEB server which does a credit card transaction and may be an authentication dedicated-computer which receives the authentication demand from the WEB server. Also, the authentication demand is the demand of a drawer with deposit, repayment of borrowed money or a loan in the ATM. In this case, the client computer 10 is an ATM. Also, the second client computer 10 to send e-mail is the portable-computer such as the cell phone. Moreover, the e-mail authentication computer 3 is the administrative server which manages a settlement in the ATM. Also, the authentication demand is the demand of the credit card transaction in the some store. In this case, the client computer 10 is the leader equipment which reads information on the credit card. Also, the second client computer 10 to send e-mail is the portable-computer such as the cell phone. Moreover, the e-mail authentication computer 3 is the administrative server which manages the settlement of the credit card in the leader equipment. Also, the authentication demand is the demand of the debit card transaction. In this case, the client computer 10 is the leader equipment which reads information on the debit card. Also, the second client computer 10 to send e-mail is the portable-computer such as the cell phone. Moreover, the e-mail authentication computer 3 is the administrative server which manages the settlement of the debit card in the leader equipment. Also, the authentication demand is the demand of the borrowing by the adding-up deferred payment with the public utility charges. In this case, the client computer 10 is an ATM. Also, the second client computer 10 to send e-mail is the portable-computer such as the cell phone. Moreover, the e-mail authentication computer 3 is the administrative server which manages borrowing in the ATM. Also, the authentication demand is the demand of the payment of the unpaid money with the public utility charges. In this case, the client computer 10 is the information computer which is installed in the convenience store and the like. Also, the second client computer 10 to send e-mail is the portable-computer such as the cell phone. Moreover, the e-mail authentication computer 3 is the administrative server which manages the information computer. Also, the authentication demand is the demand of the connection to the company intranet. In this case, the e-mail authentication computer 3 is the administrative server which manages the company intranet. Also, the authentication demand is the demand of the connection by thin client computer to the server. In this case, the e-mail authentication computer 3 is the administrative server which manages a connection between the thin client computer and the server. Also, the authentication demand is the demand of the connection to the access point of the wireless LAN. In this case, the e-mail authentication computer 3 is the administrative server which manages a connection between the client computer 10 and the access point. The authentication demand in this embodiment doesn't contain a user ID and a password but the e-mail authentication computer 3 can processes an authentication. Incidentally, the e-mail authentication computer 3 may improve safety by executing conventional authentication processing with the authentication processing in this embodiment. For example, the e-mail authentication computer 3 may authenticate by checking off the peculiar information of the user with the authentication processing in this embodiment. For example, the peculiar information of the user includes at least one out of the user name, the password, the credit card number, the cache card number, the biological information of the user, the e-mail address and the phone number. But, the peculiar information of the user is desirable that except the e-mail address which is registered to the e-mail address 3422 of user management table 342. For the malevolence person who tries to pretend the right user knows the e-mail address which is registered to user management table 342, the safety of the authentication system in this embodiment doesn't improve. Next, the concrete instance of the authentication way of checking off the peculiar information of the user is described. Specifically, the e-mail authentication computer 3 may authenticate by checking off at least one of the user ID and the password. In this case, the e-mail authentication computer 3 memorizes the correspondence of the user ID and the peculiar information of the user beforehand. On the other hand, the user who tries to be authenticated inputs the peculiar information of the user to the client computer 10. The input in this case includes making a card reader read a card in addition to the one by the operation of the key board and so on. In other words, it may be whatever one as far as the client computer 10 can acquire the peculiar information of the user. Also, the input timing of the peculiar information of the user is good anytime. The client computer 10 sends the input peculiar information of the user to the e-mail authentication computer 3. Incidentally, the client computer 10 includes the input peculiar information of the user in the authentication demand or the authentication result demand, the input peculiar information of the user may be sent dependently or independently. The e-mail authentication computer 3 receives the peculiar information of the user from the client computer 10. The authentication module 338 of the e-mail authentication computer 3 specifies the publisher of the authentication demand in the step ST123 of the processing (FIG. 7) of an individual authentication way. Next, the e-mail authentication computer 3 specifies the peculiar information of the user which is corresponded to the user ID of the specified publisher. Next, the authentication module 338 of the e-mail authentication computer 3 judges whether the peculiar information of the specified user and the peculiar information received from the client computer 10 matches or not. Then, when the two peculiar information matches, it judges the authentication of the e-mail authentication computer 3 to be possible. On the other hand, when the two peculiar information doesn't match, it judges the authentication of the e-mail authentication computer 3 to be impossible.

Also, the user in this embodiment may not be a person and may be a computer. For example, the computer may be authenticated as the user.

### Second Embodiment

The individual authentication system of the second embodiment is explained but the part which overlaps the individual authentication system of the first embodiment is omitted an explanation by using the same mark.

Because the composition of the individual authentication system of the second embodiment is identical with the individual authentication system (FIG. 1) of the first embodiment, an explanation is omitted about this. But, in the second embodiment, the network 9 is the Internet. Also, the client computer 10 sends an authentication demand and an authentication result demand to the e-mail authentication computer 3 by HTTP. Moreover, the client computer 10 receives the authentication e-mail address and the authentication result from the e-mail authentication computer 3 by HTTP. Therefore, when the client computer 10 is a cell phone, it is equipped a WEB browser function and an e-mail transmitter function. Also, the e-mail authentication computer 3 is equipped with the WEB server function and the e-mail reception server function.

Next, the individual authentication way of the second embodiment is described using FIG. 7. The individual authentication way of the second embodiment is identical with the individual authentication way in the first embodiment except for ST116 and ST124. Therefore, the explanation is omitted because of the identical processing.

Almost, the step S116 is described. The e-mail authentication computer 3 generates the WEB page which contains the generated authentication e-mail address. Next, the e-mail authentication computer 3 sends the generated WEB page and the generated authentication demand ID to the client computer 10.

The WEB page (being omitted representation) which is generated by the e-mail authentication computer 3 includes the authentication e-mail address and the authentication result demand button and is displayed on the client computer 10. The authentication result demand button accepts the instruction of the sending the authentication result demand from the user. In other words, when the authentication result demand button is operated by the user, the client computer 10 sends the authentication result demand to the e-mail authentication computer 3. Incidentally, the WEB page which is generated by the e-mail authentication computer 3 may not include the authentication result demand button. The client computer 10 sends the authentication result demand to the e-mail authentication computer 3 by the regular interval without making as the start of the user operation in this case.

Next, the step S124 is described. The e-mail authentication computer 3 generates the WEB page which includes the authentication result. Next, the e-mail authentication computer 3 sends the generated WEB page to the client computer 10 as the authentication result. Incidentally, when the authentication result is possible to authenticate, the peculiar information of the user corresponding to an user ID may be included in the WEB page which was generated by the e-mail authentication computer 3.

Incidentally, instead of the authentication demand ID, it may use a session ID. The session ID is the identifier which identifies the communication between the WEB server and the WEB browser. The generation and the management of the session ID are the function of the usual WEB server and the usual WEB browser. Therefore, the detailed explanation of the session ID is omitted.

### Third Embodiment

The individual authentication system of the third embodiment is explained below but the part which overlaps the individual authentication system of the first embodiment or the individual authentication system of the second embodiment omit an explanation by using the same mark.

The e-mail authentication computer 3 which the individual authentication system of the second embodiment is equipped with is equipped with an authentication function and the transmitter function of the WEB page which contains the peculiar information of the user. To change a conventional WEB server at this time to be equipped with the function of the e-mail authentication computer 3, the change of the program of the WEB server is indispensable. On the other hand, in the third embodiment, the embodiment which it is possible to introduce easily is described in the individual authentication way of this invention to the conventional WEB server. It makes the conventional WEB server that the individual authentication system of the third embodiment is equipped an introduction WEB server 5.

FIG. 8 is the schematic of the outline of the individual authentication system of the third embodiment. The individual authentication system which is shown in FIG. 8 is equipped with the plural client computers 10, the introduction WEB server 5 and the e-mail authentication dedicated-computer 943. Incidentally, the client computer 10, the introduction WEB server 5 and the e-mail authentication dedicated-computer 943 are mutually connected via the network 9. Because the composition of the client computer 10 is identical with the client computer 10 (FIG. 2) which the individual authentication system of the first embodiment is equipped with, an explanation is omitted. The introduction WEB server 5 is a conventional WEB server. Because the composition of the e-mail authentication dedicated-computer 943 is identical with the e-mail authentication computer 3 (FIG. 3) which the individual authentication system of the first embodiment is equipped with, an explanation is omitted. Incidentally, to make an explanation clear, in the explanation of the individual authentication system of the third embodiment, the domain “dounyu.jp” is made allocated for the introduction WEB server 5. Also, the domain “ninsho.jp” is made allocated for the e-mail authentication dedicated-computer 943.

Next, the individual authentication way of the third embodiment is described using the figure. FIG. 9 is the sequence chart of the processing of the individual authentication way of the third embodiment. The client computer 10 sends the demand of the WEB page for the log-in to the introduction WEB server 5 (ST94109) as a start of the user operation. The introduction WEB server 5 receives the demand of the WEB page for the log-in from the client computer 10. Then, the introduction WEB server 5 sends the WEB page for the log-in which includes an authentication site information to the client computer 10 via the network 9 (ST94110). The WEB page for the concerned log-in includes the authentication site information. The authentication site information is the information which prompts for the sending of an authentication demand to the e-mail authentication dedicated-computer 943 to the client computer 10. Also, the authentication site information includes the return URL. The return URL indicates destination of the demand of the WEB page for the member from the client computer 10. The demand of the WEB page for the member is sent after authentication completion which depends on the e-mail authentication dedicated-computer 943. Here, the example of the authentication site information is shown. For example, the authentication site information is “<SCRIPT SRC=‘http://www.ninsho.jp/index.php?rurl=http://www.dounyu.jp/membe r.php’></SCRIPT>”. The URL after “rurl=” is the return URL. Also, for example, the authentication site information is “<A HREF=‘http://www.ninsho.jp/index.php?rurl=http://www.dounyu.jp/mem ber.php’>the authentication is this </A>”. The URL after “rurl=” is the return URL. The authentication site information may be the other one as far as it achieves the purpose. Next, the client computer 10 sends the authentication demand to the e-mail authentication dedicated-computer 943 based on the authentication site information which is contained in the received WEB page (ST111). The e-mail authentication dedicated-computer 943 receives the authentication demand. Then, e-mail authentication dedicated-computer 943 extracts the return URL from the received authentication demand (ST94112). Next, the e-mail authentication dedicated-computer 943 generates the authentication demand ID and the authentication e-mail address (ST113 ST114). Next, after the e-mail authentication dedicated-computer 943 matches to the authentication demand ID, the authentication e-mail address and the return URL, it memorizes them at the authentication e-mail address mapping table 341 (ST94115). Therefore, the authentication e-mail address mapping table 341 includes the return URL (being omitted representation). Specifically, the e-mail authentication dedicated-computer 943 generates a new record in the authentication e-mail address mapping table 341. Next, the e-mail authentication dedicated-computer 943 memorizes the generated authentication demand ID in the authentication demand ID3411 of the newly generated record. Next, the e-mail authentication dedicated-computer 943 memorizes the generated authentication e-mail address in the authentication e-mail address 3412 of the newly created record. Next, the e-mail authentication dedicated-computer 943 memorizes the extracted return URL in the return URL of the newly created record. Next, the e-mail authentication dedicated-computer 943 sends the generated authentication demand ID and the authentication e-mail address to the client computer 10 (ST94116). The client computer 10 receives the authentication demand ID and the authentication e-mail address (ST117). Next, the client computer 10 sends the e-mail for the received authentication e-mail address resembles (ST118). Then, the e-mail authentication dedicated-computer 943 receives the e-mail from the client computer 10 (ST119). Next, the e-mail authentication dedicated-computer 943 specifies a source e-mail address and a destination e-mail address from the received e-mail. Next, after the e-mail authentication dedicated-computer 943 corresponds the authentication demand ID corresponding the specified destination e-mail address to the specified the source e-mail address, it memorizes them in the authentication e-mail address mapping table 341 (ST120). On the one hand, the client computer 10 sends the authentication result demand to the e-mail authentication dedicated-computer 943 (ST121). Then, the e-mail authentication dedicated-computer 943 receives the authentication result demand from the client computer 10 (ST122). The e-mail authentication dedicated-computer 943 extracts the authentication demand ID from the received authentication result demand. Next, the e-mail authentication dedicated-computer 943 extracts the user e-mail address 3413 corresponding to the extracted authentication demand ID from the authentication e-mail address mapping table 341. Next, the e-mail authentication dedicated-computer 943 judges whether the extracted user e-mail address 3413 is memorized in the e-mail address 3422 of user management table 342 or not (ST123). When the user e-mail address 3413 is memorized in user management table 342, it judges the authentication of e-mail authentication dedicated-computer 943 to be possible. On the other hand, when the user e-mail address 3413 isn't memorized in user management table 342, it judges the authentication of the e-mail authentication dedicated-computer 943 to be impossible. Next, the e-mail authentication dedicated-computer 943 sends the result of the authentication to the client computer 10 (ST94124). Specifically, the e-mail authentication dedicated-computer 943 chooses a record where the authentication demand ID3411 of the authentication e-mail address mapping table 341 matches the extracted authentication demand ID from the authentication e-mail address mapping table 341. Next, the e-mail authentication dedicated-computer 943 extracts the return URL and the user e-mail address 3413 from the chosen record. Next, the e-mail authentication dedicated-computer 943 generates the WEB page which includes the return source URL and the e-mail address of the user as a result of the authentication. The example of the source code which is contained in the generated WEB page here is shown. For example, the source code is “<meta http-equiv=“Refresh”content=“0;url=http://www.dounyu.jp/member.php?us rmail=taka@yahoo.co.jp&auth=1”>”. The URL after “url=” is the return source URL. The e-mail address after “usrmail=” is the e-mail address of the user. The value after “auth=” is the result of the authentication. For example, it is possible to authenticate “1” and it is impossible to authenticate “0”. But, “auth=” doesn't have to be necessarily included. Also, for example, the source code is “<A HREF=“http://www.dounyu.jp/member.php?usrmail=taka@yahoo.co.jp&aut h=1”>the member page is this</A>”. The URL after “url=” is the return URL. The e-mail address after “usrmail=” is the e-mail address of the user. The value after “auth=” is the result of the authentication. For example, it is possible to authenticate “1” and it is impossible to authenticate “0”. But, “auth=” doesn't have to be necessarily included. Incidentally, the source code which the above-mentioned WEB page contains may be the other one as far as it achieves the purpose. Next, the e-mail authentication dedicated-computer 943 sends the generated WEB page to the client computer 10 as the result of the authentication. The client computer 10 receives the WEB page which was sent as the result of the authentication (ST125). Next, the client computer 10 sends the demand of the WEB page for the member to the introduction WEB server 5 based on the received WEB page (ST94126). The demand of the WEB page for the member which is sent by the client computer 10 includes the e-mail address of the user. For example, the demand of the WEB page for the member is a URL, “http://www.dounyu.jp/member.php?usrmail=taka@yahoo.co.jp&auth=1”. The e-mail address after “usrmail=” is the e-mail address of the user. The introduction WEB server 5 receives the demand of the WEB page for the member from the client computer 10. Next, the introduction WEB server 5 extracts the e-mail address of the user from the demand of the received WEB page for the member. Next, the introduction WEB server 5 specifies a user based on the extracted e-mail address. Next, e-mail authentication dedicated-computer 943 generates the WEB page for the member corresponding to the specified user. Next, the introduction WEB server 5 sends the generated WEB page for the member to the client computer 10 via the network 9 (ST94127). Incidentally, the WEB page for the member includes the peculiar information of the user corresponding to the user of the extracted e-mail address. Next, the client computer 10 receives the WEB page for the member from the introduction WEB server 5. Next, the client computer 10 displays the received WEB page for the member in the display (ST94128).

The introduction WEB server 5 which is a conventional WEB server as above-mentioned can introduce the individual authentication way of this invention by including authentication site information in the WEB page for the log-in to send to the client computer 10 only.

In the above-mentioned embodiment, the e-mail authentication dedicated-computer 943 memorizes the user management table 342. However, the e-mail authentication dedicated-computer 943 may not memorize always the user management table 342. In this case, the introduction WEB server 5 memorizes the user management table 342. In this case, the e-mail authentication dedicated-computer 943 don't have to judge whether the extracted user e-mail address 3413 is memorized in the e-mail address 3422 of the user management table 342 or not in step ST 123. In the substitute, the introduction WEB server 5 judges whether the e-mail address which is contained in the demand of the WEB page for the member which receives from the client computer 10 is memorized in user management table 342 or not.

In the above-mentioned embodiment, the introduction WEB server 5 trusts the e-mail address which is contained in the demand of the received WEB page for the member from the client computer 10 and sends the WEB page for the member. However, the e-mail address which is contained in the demand of the WEB page for the member is to be counterfeited sometimes. Therefore, the introduction WEB server 5 may confirm that the link source is the e-mail authentication dedicated-computer 943 by referring to “referrer”.

Here, the transformation example of the third embodiment of the present invention is described. In the third embodiment, the e-mail authentication dedicated-computer 943 generates the authentication demand ID. However, the introduction WEB server 5 may generate the authentication demand ID instead of the e-mail authentication dedicated-computer 943. In this case, the introduction WEB server 5 memorizes the generated authentication demand ID. Next, the introduction WEB server 5 sends the authentication site information which includes the generated authentication demand ID to the client computer 10. The client computer 10 extracts the authentication demand ID from the received authentication site information. Next, the client computer 10 sends the authentication demand which includes the extracted authentication demand ID to the e-mail authentication dedicated-computer 943. The e-mail authentication dedicated-computer 943 receives the authentication demand from the client computer 10 instead of the generating authentication demand ID. Next, the authentication demand ID and the authentication e-mail address which is contained in the received authentication demand are matched by the e-mail authentication dedicated-computer 943 and the e-mail authentication dedicated-computer 943 memorizes them in the authentication e-mail address mapping table 341. The e-mail authentication dedicated-computer 943 sends the WEB page which includes the authentication demand ID which is memorized in the authentication e-mail address mapping table 341 to the client computer 10 as a result of the authentication. The client computer 10 receives the result of the authentication from the e-mail authentication dedicated-computer 943. Next, the client computer 10 sends the demand of the WEB page for the member to the introduction WEB server 5 based on the received result of the authentication. Here, the client computer 10 sends the demand of the WEB page for the member which includes the authentication demand ID to introduction WEB server 5. The introduction WEB server 5 receives the demand of the WEB page for the member from the client computer 10. Next, the introduction WEB server 5 extracts the authentication demand ID from the received demand of the WEB page for the member. Next, the introduction WEB server 5 judges whether the extracted authentication demand ID is memorized or not. The introduction WEB server 5 sends WEB page for the member to the client computer 10 when memorizing the authentication demand ID. On the other hand, when the introduction WEB server 5 doesn't memorize the authentication demand ID, the demand of the received WEB page for the member is judged to be camouflaged. Therefore, the introduction WEB server 5 doesn't send WEB page for the member. Incidentally, when the e-mail authentication dedicated-computer 943 is connected with the plural introduction WEB servers 5, each introduction WEB server 5 generates the unique authentication demand ID in the individual authentication system. For example, the introduction WEB server 5 generates the unique authentication demand ID in the individual authentication system by generating the authentication demand ID which contains the unique identifier of the concerned introduction WEB server 5.

### The Fourth Embodiment

The individual authentication system of the forth embodiment is explained below but the part which overlaps the individual authentication system of the third embodiment is omitted an explanation by using the same mark.

In the e-commerce on the Internet, as the settlement means, a credit card is often used. In the forth embodiment, the example which applies the individual authentication system of the third embodiment to the credit card transaction on the Internet is described.

Because the schematic of the outline of the individual authentication system of the forth embodiment is identical with the schematic (FIG. 8) of the outline of the individual authentication system of the third embodiment, the explanation of the details are omitted. The client computer 10 is operated by the user who tries to execute a credit card transaction. The introduction WEB server 5 is the WEB server which provides the e-commerce such as the sale of goods or the retailing of services and the like. The e-mail authentication dedicated-computer 943 is the WEB equipment which processes the credit administration and the accounting of the credit card. The user management table 342 of the e-mail authentication dedicated-computer 943 includes a credit card number (being omitted representation). The credit card number which is included in the user management table is the number of the credit card of the user. After the credit card number and the e-mail address of the user who possesses a concerned credit card are matched, these are memorized in the user management table 342. Also, the authentication e-mail address mapping table 341 of the e-mail authentication dedicated-computer 943 includes a settlement amount (being omitted representation). The settlement amount which is included in the authentication e-mail address mapping table 341 is the amount of money to try to settle with the credit card.

The overview of the processing of the individual authentication way of the forth embodiment is described. The introduction WEB server 5 fixes a settlement amount as a start of the operation of the user. The way of settlement amount's being fixed may be the way of being adopted at the site of the conventional e-commerce. Next, the client computer 10 instead of the demand of the WEB page for the log-in as a start of the user operation sends the demand of the WEB page for the settlement to the introduction WEB server 5. The introduction WEB server 5 receives the demand of the WEB page for the settlement. Then, the introduction WEB server 5 generates the required WEB page for the settlement. Next, the introduction WEB server 5 sends the generated WEB page for the settlement to the client computer 10. The WEB page for the settlement which is produced by the introduction WEB server 5 includes the authentication site information. The authentication site information includes the settlement amount in addition to the return URL. The client computer 10 receives the WEB page for the settlement. Next, the client computer 10 sends the authentication demand to the e-mail authentication dedicated-computer 943 based on the authentication site information which is included in the received WEB page for the settlement. The e-mail authentication dedicated-computer 943 receives the authentication demand. Next, e-mail authentication dedicated-computer 943 extracts the return URL and the settlement amount from the received authentication demand. Next, the e-mail authentication dedicated-computer 943 generates an authentication demand ID and an authentication e-mail address. Next, after the generated authentication demand ID, the generated authentication e-mail address, the extracted return URL and the extracted settlement amount are matched by the e-mail authentication dedicated-computer 943, these are memorized in the authentication e-mail address mapping table 341. Next, the e-mail authentication dedicated-computer 943 sends the generated authentication demand ID and the generated authentication e-mail address to the client computer 10. The client computer 10 receives the authentication demand ID and an authentication e-mail address. Next, the client computer 10 sends the e-mail to the authentication e-mail address. By this, the client computer 10 sends the e-mail to e-mail authentication dedicated-computer 943. The e-mail authentication dedicated-computer 943 receives the e-mail from the client computer 10. Then, the e-mail authentication dedicated-computer 943 acquires the destination e-mail address and the source e-mail address from the received e-mail. Next, after e-mail authentication dedicated-computer 943 matches the authentication demand ID corresponding to the acquired destination e-mail address and the acquired source e-mail address, these are memorized in the authentication e-mail address mapping table 341. On the one hand, the client computer 10 sends the authentication result demand to the e-mail authentication dedicated-computer 943. The e-mail authentication dedicated-computer 943 receives the authentication result demand from the client computer 10. The e-mail authentication dedicated-computer 943 extracts the authentication demand ID from the received authentication result demand. Next, the e-mail authentication dedicated-computer 943 extracts the e-mail address and the settlement amount corresponding to the extracted authentication demand ID from the authentication e-mail address mapping table 341. Next, the e-mail authentication dedicated-computer 943 extracts the credit card number corresponding to an extracted e-mail address from the user management table 342. Next, the e-mail authentication dedicated-computer 943 does a credit administration to judge it is available in the extracted settlement amount by using the extracted credit card number or not. The credit administration in this place is same as the credit administration of the conventional credit card utility-time. The e-mail authentication dedicated-computer 943 charges the settlement amount for the credit card when the credit administration is good. The e-mail authentication dedicated-computer 943 may request a computer which does a credit administration processing and an accounting to do the credit administration processing and the accounting. When the e-mail authentication dedicated-computer 943 completes the accounting, it judges authentication to be possible about the result of the authentication. The e-mail authentication dedicated-computer 943 sends the result of the authentication to the client computer 10. The client computer 10 sends the demand of the WEB page of the settlement ending to the introduction WEB server 5 based on the result of the received authentication. The introduction WEB server 5 receives the demand of the WEB page of the settlement ending from the client computer 10. Next, the introduction WEB server 5 extracts the e-mail address of the user from the demand of the WEB page. Next, the introduction WEB server 5 sends the WEB page of the settlement ending corresponding to the extracted e-mail address to the client computer 10. Incidentally, the WEB page of the settlement ending includes the peculiar information of the user corresponding to the extracted e-mail address.

As above-mentioned, the individual authentication system of the third embodiment can be applied to the settlement of the credit card. Incidentally, in the forth embodiment, a credit card transaction was explained but the settlement means may be anything as far as it is the means to settle the authentication later. For example, there are “Edy” (the trademark), “Jay debit” (the trademark) or “the cell phone payment service” (the trademark) and so on in the settlement means. The “Edy” (the trademark) is available electronic money in the stores and on the Internet. The “Jay debit” (The trademark) is the settlement service of the available deposit account pulling down in the stores and on the Internet. The “cell phone payment service” (the trademark) is the settlement service of the available deferred payment on the Internet. In the “cell phone payment service”, the settlement amount adds to a cell phone fee.

Here, the transformation example of the individual authentication system of the forth embodiment is described. The e-mail authentication dedicated-computer 943 which the individual authentication system of the forth embodiment is equipped with specified a credit card number based on the source e-mail. Therefore, when the source e-mail is camouflaged, it has been settled by the pretended user. To prevent from the pretended settlement, the user inputs a credit card number to the client computer 10. The client computer 10 sends the entered credit card number to the e-mail authentication dedicated-computer 943. Incidentally, the client computer 10 includes the entered credit card number in the authentication demand or the authentication result demand and may send it. The e-mail authentication dedicated-computer 943 receives the credit card number from the client computer 10. Then, the e-mail authentication dedicated-computer 943 memorizes the received credit card number. The overview of the transformation example is as follows. The introduction WEB server 5 sends the WEB page for the settlement which includes the entry field of the credit card number to the client computer 10. The user of the client computer 10 inputs a credit card number to the entry field of the credit card number of the WEB page for the settlement. The entry in this place makes a card reader read a card in addition to the one by the operation of the key board and so on, and the like, and includes it. In other words, it may be whatever one as far as it is possible for the credit card number to be acquired by the client computer 10. The client computer 10 sends the authentication demand which includes the entered credit card number to the e-mail authentication dedicated-computer 943. The e-mail authentication dedicated-computer 943 extracts the credit card number from the authentication demand which was received from the client computer 10. Next, after the e-mail authentication dedicated-computer 943 matches the extracted credit card number and the authentication demand ID, it memorizes them in the authentication e-mail address mapping table 341. On the one hand, the e-mail authentication dedicated-computer 943 receives the authentication result demand from the client computer 10. Then, the e-mail authentication dedicated-computer 943 extracts the credit card number corresponding to the authentication demand ID which is contained in the received authentication result demand from the user management table 342. By this, the e-mail authentication dedicated-computer 943 extracts the credit card number to use for the settlement from the user management table 342. Next, the e-mail authentication dedicated-computer 943 checks off the extracted credit card number and the credit card number which is memorized in the authentication e-mail address mapping table 341. When the credit card number of both matches, the e-mail authentication dedicated-computer 943 performs a credit administration and charges the settlement amount for the concerned credit card. Also, it may be as follows. The e-mail authentication dedicated-computer 943 receives the authentication demand from the client computer 10. The e-mail authentication dedicated-computer 943 sends the WEB page which includes the authentication e-mail address to the client computer 10. Moreover, the WEB page which contains the authentication e-mail address includes the entry field of the credit card number. The user of the client computer 10 inputs a credit card number to the entry field of the credit card number of the WEB page which contains the authentication e-mail address. The client computer 10 sends the authentication result demand which includes the entered credit card number to the e-mail authentication dedicated-computer 943. The e-mail authentication dedicated-computer 943 receives the authentication result demand from the client computer 10 as above-mentioned. Then, the e-mail authentication dedicated-computer 943 extracts the credit card number corresponding to the authentication demand ID which is included in the received authentication result demand from the user management table 342. By this, the e-mail authentication dedicated-computer 943 extracts the credit card number to use for the settlement from the user management table 342. Next, the e-mail authentication dedicated-computer 943 checks off the extracted credit card number and the credit card number which is included in the authentication result demand. When the credit card number of both matches, the e-mail authentication dedicated-computer 943 a credit administration and charges the settlement amount for the concerned credit card. Incidentally, by making enter the other information such as the PIN and the like instead of making a user enter the credit card number in the transformation example of the fourth embodiment, it may prevent from fishing fraud.

### Fifth Embodiment

The individual authentication system of the fifth embodiment is explained below but the part which overlaps the individual authentication system of the first embodiment is omitted an explanation by using the same mark.

FIG. 10 is the schematic of the outline of the individual authentication system of the fifth embodiment. The individual authentication system which is shown in FIG. 10 is equipped with the plural ATMs (AUTOMATIC TELLER MACHINE) 2010, the plural cell phones 60 and the ATM e-mail authentication computer 923. The ATM2010 is automatic teller machine which is operated by the user who tries to deposit and withdraw the cash, and authenticated. The ATM2010 may be the ATM equipped with the general financial institution. The ATM e-mail authentication computer 923 is connected with the ATM2010 via the network 9. In the fifth embodiment, the network 9 is the internal network. Also, it is good even if network 9 contains a relay computer by which the plural ATM e-mail authentication computers which are installed in each financial institution are managed. Also, the ATM e-mail authentication computer 923 is connected with the cell phone 60 via the Internet 1. Because the composition of ATM e-mail authentication computer 923 is identical with the e-mail authentication computer 3 (FIG. 3) which the individual authentication system of the first embodiment is equipped with, an explanation is omitted. Incidentally, in FIG. 10, ATM2010 illustrated two but the individual authentication system may be equipped with them how many. Also, the cell phone 60 illustrated two but the individual authentication system may be equipped with how many. Incidentally, the individual authentication system may be equipped with whatever terminal which is equipped with the e-mail transmitter function instead of the cell phone 60. The ATM2010 is physically equipped with a sending/receiving device, a central processing device, a main storage device, the auxiliary storage device, the input device, the display device and the cash handling device and so on. The cash handling device manages a bill and money physically. Moreover, the cash handling device does a bill and money in the income and expense. Incidentally, because the function of the ATM2010 is identical with the client computer 10 which the individual authentication system of the first embodiment is equipped with except for the cash handling device, an explanation is omitted.

The cell phone 60 has an Internet access function. Therefore, the cell phone 60 sends the e-mail to the ATM e-mail authentication computer 923 via the network 1.

Because the functional composition of the ATM e-mail authentication computer 923 of the fifth embodiment is identical with the e-mail authentication computer 3 (FIG. 4) which the individual authentication system of the first embodiment is equipped with, an explanation is omitted. Incidentally, the peculiar information of the user corresponding to the user ID is memorized in the user management table 342 which is memorized in the auxiliary storage of the ATM e-mail authentication computer 923. The peculiar information of the user on this embodiment is the account information of the financial institution. The account information of the financial institution includes an account number, a balance, a loan balance and a borrowable balance and the like. But, the peculiar information of the user may be whatever way if to be always managed by the user management table 342 isn't necessary and managed, corresponding to the user ID. The part of the peculiar information of the user corresponding to the user ID is included in the result of the authentication which is sent to the ATM2010 from the ATM e-mail authentication computer 923.

Next, the individual authentication way of the fifth embodiment is described. Because the processing of the individual authentication way of the fifth embodiment is identical with the individual authentication way (FIG. 7) of the first embodiment, an explanation is omitted. But, this place describes the characteristic step of the individual authentication way of the fifth embodiment.

The ST118 of the fifth embodiment is described. The equipment which becomes a source of the e-mail is not the ATM2010 but is the cell phone 60 which is the second client computer. The cell phone 60 sends to the e-mail to the ATM e-mail authentication computer 923 as a start of the user operation.

The ST124 of the fifth embodiment is described. The authentication result sending module 339 of the ATM e-mail authentication computer 923 sends the result of the authentication to the ATM2010 via the network 9. The result of the authentication includes the peculiar information of the user with the account number, the balance, the loan balance or the borrowable balance corresponding to the user ID and the like.

After the ST124, the ATM2010 displays the result of the authentication and the peculiar information of the user, on the display device, which was received from the ATM e-mail authentication computer 923. The user of the ATM2010 executes the operation of the following based on the displayed information. For example, the operation of the following is a drawer with the deposit, the return of the loan or the borrowing of a loan.

By the way, the general ATM can accept various operations such as the drawer with the deposit, the return of the loan and the borrowing of a loan. Therefore, before the ST111, the ATM2010 accepts the kind of the operation from the user. The ATM2010 includes the kind of the operation which the user demands in the authentication demand to send to the ATM e-mail authentication computer 923. The ATM e-mail authentication computer 923 extracts the kind of the operation which the user of the ATM2010 finds from the received authentication demand from the ATM2010. Then, the ATM e-mail authentication computer 923 specifies the peculiar information of the user which includes in the result of the authentication based on the kind of the extracted operation.

Also, it may be the following procedure. The general ATM can accept various operations such as the drawer with the deposit, the return of the loan and the borrowing of a loan. This place beforehand the ATM e-mail authentication computer 923 memorizes beforehand the operation which can accept from the user of the ATM2010, corresponding to the user ID. In this case, the ATM2010 doesn't accept the kind of the operation from the user before sending of the authentication demand. Almost, the ATM2010 is authenticated by the individual authentication way of the fifth embodiment. The ATM e-mail authentication computer 923 includes the operation which is possible about the reception desk corresponding to the authenticated user ID in the result of the authentication and sends it to the ATM2010. The ATM2010 displays the operation which can accept and a result of the authentication which was received from the ATM e-mail authentication computer 923 on the display device. The user of the ATM2010 chooses the operation from the inside of the kind of the operation which was displayed on the display device of ATM2010. Then, the ATM2010 executes the operation of the chosen kind.

Incidentally, the individual authentication way of the fifth embodiment may combine with the individual authentication way by the conventional cash card and the PIN. Unless the e-mail is sent from the mail address of the user even if a cash card and PIN are stolen by this, a deposit is never drawn out by the user of the becoming finishing. Also, the individual authentication way of the fifth embodiment may combine with the individual authentication by either of the cash cards or the PIN.

Here, the transformation example of the fifth embodiment of this invention is described. In the fifth embodiment, the ATM e-mail authentication computer 923 generates and sends the authentication demand ID to the ATM2010. However, in the transformation example, the ATM2010 may send the authentication demand which contains its own ATM_ID to the ATM e-mail authentication computer 923. The ATM_ID is the unique identifier of the ATM2010. Then, the ATM e-mail authentication computer 923 extracts the ATM_ID from the authentication demand. Then, the extracted ATM_ID and the authentication e-mail address are matched and memorized by the ATM e-mail authentication computer 923. In this case, the authentication e-mail address mapping table 341 includes the ATM_ID instead of the authentication demand ID3411. Incidentally, the ATM2010 never sends the authentication demand which is different, before the processing of a one corner authentication demand completes, to the ATM e-mail authentication computer 923. Therefore, the compatible of the ATM_ID and the authentication e-mail address becomes 1 to 1. When the ATM e-mail authentication computer 923 receives the e-mail from the cell phone 60, it specifies the ATM_ID corresponding to a source e-mail address of the received e-mail. Then, the ATM e-mail authentication computer 923 sends the result of the authentication to the ATM2010 which is identified by the specified ATM_ID. In other words, even if the ATM e-mail authentication computer 923 doesn't receive the authentication result demand from the ATM2010, the result of the authentication can be sent.

Here, the applied example of the fifth embodiment of the present invention is described. The ATM e-mail authentication computer 923 which the individual authentication system of the applied example of the fifth embodiment is equipped with combines the computer which computes a fee with the public utility charges. In this case, the ATM e-mail authentication computer 923 computes the public utility charges, publishes a bill and manages the payment status. For example, the public utility charges are a phone bill, a cell phone fee, electricity charges, a gas charge or a water bill and the like. The ATM e-mail authentication computer 923 matches the e-mail address of the cell phone 60 and the identifier of the user who receives the service of the public utility charges and memorizes them. The ATM e-mail authentication computer 923 requires a loan in addition to the demand of the public utility charges, when lending the user of the ATM2010 a loan. Also, the ATM e-mail authentication computer 923 accepts the demand of the payment with the public utility charges from the user of the ATM2010. When the ATM e-mail authentication computer 923 authenticate the user of the ATM2010 above-mentioned, it accepts payment with public utility charges of the unpaid part of the user of the cell phone 60 from the ATM2010. Also, the ATM e-mail authentication computer 923 accepts the demand of the rent of the loan from the user of the ATM2010. When the ATM e-mail authentication computer 923 authenticate the user of the ATM2010 above-mentioned, it lends a loan from the ATM2010. Incidentally, the ATM e-mail authentication computer 923 requires a loan in addition to the demand of the public utility charges.

Also, in the fifth embodiment of this invention, it may allocate the authentication e-mail address which doesn't overlap for each of all ATM2010 beforehand. In this case, the compatible of the ATM2010 and the authentication e-mail address is invariable and it memorizes beforehand in the authentication e-mail address mapping table 341 and the like. Then, the ATM e-mail authentication computer 923 can specify the ATM2010 of the source authentication demand of the user based on the destination e-mail address.

### Sixth Embodiment

The individual authentication system of the sixth embodiment is explained below but the part which overlaps the individual authentication system of the first embodiment and the individual authentication system of the fifth embodiment omits an explanation by using the same mark.

The specific embodiment which uses the individual authentication system of the first embodiment for the credit card transaction in the store as the individual authentication system of the sixth embodiment is described. In the past, in the credit card transaction at the store, to prevent from the use of the becoming finishing, the salesperson at the store checks off the signature of the use slip and a signature in the credit card back by the watching. However, the check of the watching is insufficient as the becoming finishing prevention measure. At the individual authentication system of the sixth embodiment, the practical example which uses an e-mail address instead of the check of the signature is described.

FIG. 11 is the schematic of the outline of the individual authentication system of the sixth embodiment. The individual authentication system which is shown in FIG. 11 is equipped with plural leader equipments 2110, the plural cell phones 60 and the e-mail authentication computer 3. The leader equipment 2110 is connected with the e-mail authentication computer 3 via the network 9. The e-mail authentication computer 3 is connected with the cell phone 60 via the Internet 1. The leader equipment 2110 is the equipment to read the credit card information. It is good if the leader equipment 2110 is the general card reader of the credit card. At the store, as for being general, the salesperson at the store operates the leader equipment 2110. However, the user who is authenticated at the individual authentication system of the sixth embodiment is the holder of the credit card. Therefore, to do an explanation easily, as for the explanation of this embodiment, the user of the leader equipment 2110 makes the holder of the credit card. Because the e-mail authentication computer 3 is identical with the e-mail authentication computer 3 (FIG. 3) which the individual authentication system of the first embodiment is equipped with, an explanation is omitted. Incidentally, in FIG. 11, the leader equipment 2110 illustrated two but the individual authentication system may be equipped with how many. Also, in FIG. 11, the cell phone 60 illustrated two but the individual authentication system may be equipped with how many. The leader equipment 2110 is physically equipped with the sending/receiving device, the central processing device, the main storage device, the auxiliary storage device, the input device, the display device and the card information read device and so on. The card information read device reads the information which is memorized in the credit card. The function of leader equipment 2110 is same as the client computer 10 which the individual authentication system of the first embodiment is mainly equipped with. Moreover, the leader equipment 2110 accepts a credit card number and a settlement amount by the operation of the user. The leader equipment 2110 includes the accepted credit card number and the accepted settlement amount in the authentication demand to send to the e-mail authentication computer 3.

The e-mail authentication computer 3 of the sixth embodiment has the following function in addition to the function of the e-mail authentication computer 3 that the individual authentication system of the first embodiment equips with. The e-mail authentication computer 3 of the sixth embodiment processes the credit administration and the accounting of the credit card. The user management table 342 of the e-mail authentication computer 3 includes a credit card number (being omitted representation). The credit card number which is included in user management table 342 is the number of the credit card which the user possesses. In other words, the credit card number and the e-mail address of the user are related and beforehand memorized at the user management table 342. Also, the authentication e-mail address mapping table 341 of the e-mail authentication computer 3 includes a settlement amount (being omitted representation) and a credit card number (being omitted representation). The settlement amount which is included in the authentication e-mail address mapping table 341 is the amount of money to try to settle by the credit card. The credit card number which is included in the authentication e-mail address mapping table 341 is the number of the credit card to try to being used for the settlement.

Next, the overview of the processing of the individual authentication way of the sixth embodiment is described using FIG. 7. Incidentally, the equipment which becomes the source of the e-mail is not the leader equipment 2110 but is the cell phone 60 which is the second the client computer.

The leader equipment 2110 accepts a settlement amount from the user. Also, the card information read device of the leader equipment 2110 reads a credit card number as the operation of the user. Next, the leader equipment 2110 sends the authentication demand which includes the accepted settlement amount and the read credit card number to the e-mail authentication computer 3 (ST111). The e-mail authentication computer 3 receives the authentication demand (ST112). Next, the e-mail authentication computer 3 extracts the settlement amount and the credit card number from the received authentication demand. Next, the e-mail authentication computer 3 generates an authentication demand ID and an authentication e-mail address (ST113 ST114). Next, after the e-mail authentication computer 3 matches the generated authentication demand ID, the generated authentication e-mail address, the extracted settlement amount and the extracted credit card number, these are memorized in the authentication e-mail address mapping table 341 (ST115).Next, the e-mail authentication computer 3 sends the generated authentication demand ID and the generated authentication e-mail address to the leader equipment 2110 (ST116). The leader equipment 2110 receives the authentication demand ID and the authentication e-mail address (ST117). Next, the leader equipment 2110 displays the authentication e-mail address which was received in the display device. Incidentally, it may print the paper of the authentication e-mail address to have been specified without displaying an authentication e-mail address by the leader equipment 2110. In other words, the leader equipment 2110 may be whatever way if the authentication e-mail address can be notified to the user. Also, the leader equipment 2110 may display and print the QR code and the like to correspond the authentication e-mail address. The cell phone 60 sends the e-mail to the displayed authentication e-mail address as a start of user operation (ST118). Then, the e-mail authentication computer 3 receives the e-mail from the cell phone 60 (ST119). Next, the source e-mail address and the destination e-mail address are acquired from the received e-mail by the e-mail authentication computer 3. Next, the e-mail authentication computer 3 relates the acquired source e-mail address with the authentication demand ID based on the acquired destination e-mail address and memorizes them in the authentication e-mail address mapping table 341 (ST120). Specifically, the e-mail authentication computer 3 chooses a record where the authentication e-mail address 3412 of the authentication e-mail address mapping table 341 matches the acquired destination e-mail address from the authentication e-mail address mapping table 341. Next, the e-mail authentication computer 3 memorizes in the user e-mail address 3413 of the chosen record the acquired source e-mail address. On the one hand, the leader equipment 2110 sends the authentication result demand to the e-mail authentication computer 3 (ST121). The e-mail authentication computer 3 receives the authentication result demand from the leader equipment 2110 (ST122). The e-mail authentication computer 3 extracts the authentication demand ID from the received authentication result demand. Next, the e-mail authentication computer 3 extracts the user e-mail address, the settlement amount and the credit card number which are related to the extracted authentication demand ID from the authentication e-mail address mapping table 341 (ST123). Specifically, the e-mail authentication computer 3 chooses the record where the authentication demand ID3411 of the authentication e-mail address mapping table 341 matches the extracted authentication demand ID from the authentication e-mail address mapping table 341. Next, the e-mail authentication computer 3 extracts the user e-mail address 3413, the settlement amount, the credit card number from the chosen record. Next, the e-mail authentication computer 3 chooses the record where the e-mail address 3422 of the user management table 342 matches the extracted user e-mail address 3413 from the user management table 342. Next, the e-mail authentication computer 3 extracts the credit card number from the chosen record. Next, the e-mail authentication computer 3 checks the credit card number extracted from the authentication e-mail address mapping table 341 and the credit card number extracted from the user management table 342. When the extracted two corner credit card number doesn't match, the e-mail authentication computer 3 judges it to be impossible. On the other hand, when the extracted two corner credit card number matches, the e-mail authentication computer 3 does the credit administration to judge whether the extracted settlement amount is available or not. The credit administration is same as the one which is done by the conventional credit card utility-time. The e-mail authentication computer 3 charges a settlement amount for the credit card when the credit administration is good. Incidentally, the e-mail authentication computer 3 may demand a credit administration and an accounting of the special computer. In this case, the e-mail authentication computer 3 is connected the special computer which does a credit administration and accounting via the network. When the e-mail authentication computer 3 completes the accounting, it judges authentication to be possible. The e-mail authentication computer 3 sends the result of the authentication to the leader equipment 2110 (ST124). The leader equipment 2110 receives the authentication result (ST125). Next, the leader equipment 2110 displays the authentication result in the display device.

As above-mentioned, the individual authentication system of the sixth embodiment could use an e-mail address instead of the check of the signature about the credit card transaction in the store. Incidentally, in the sixth embodiment, a credit card transaction was explained but the settlement means may be whatever way if it is the means to settle via the authentication and it is not limited to the credit card. For example, there is “Jay debit” (the trademark) in the settlement means.

The authentication demand which is sent by the leader equipment 2110 includes the credit card number in the above mentioned embodiment. However, it may be as follows. The leader equipment 2110 may include the credit card number in the authentication result demand, not being the authentication demand. In this case, the authentication e-mail address mapping table 341 of the e-mail authentication computer 3 doesn't have to include a credit card number. The leader equipment 2110 sends the authentication result demand to the e-mail authentication computer 3. The e-mail authentication computer 3 receives the authentication result demand from the leader equipment 2110. Next, the e-mail authentication computer 3 extracts the authentication demand ID from the received authentication result demand. Next, the e-mail authentication computer 3 chooses a record where the authentication demand ID3411 of the authentication e-mail address mapping table 341 matches the extracted authentication demand ID from the authentication e-mail address mapping table 341. Next, the e-mail authentication computer 3 extracts the user e-mail address 3413 and the settlement amount from the chosen record. Next, the e-mail authentication computer 3 chooses the record where the e-mail address 3422 of the user management table 342 matches the extracted user e-mail address 3413 from the user management table 342. Next, the e-mail authentication computer 3 extracts the credit card number from the chosen record. Next, the e-mail authentication computer 3 checks the credit number to have extracted from the user management table 342 with the credit card which is included in the authentication result demand. When the two corner credit card number matches, the e-mail authentication computer 3 does a credit administration and charges.

Next, the transformation example of the sixth embodiment of this invention is described. At the individual authentication system of the sixth embodiment, the leader equipment 2110 read the information on the credit card. However, even if there is not a reading of the information on the credit card which depends on the leader equipment 2110 in the transformation example of the sixth embodiment, the example that the credit card transaction can be executed is described. That is, even if the user doesn't possess the credit card physically, a credit card transaction can be executed at the store.

The authentication demand sent by the leader equipment 2110 which the transformation example of the sixth embodiment is equipped with doesn't include a credit card number. Also, the authentication e-mail address mapping table 341 of the e-mail authentication computer 3 which the transformation example of the sixth embodiment is equipped with doesn't include a credit card number.

The overview of the processing of the transformation example of the sixth embodiment is described. The leader equipment 2110 sends as a start of the user operation the authentication demand to the e-mail authentication computer 3. The e-mail authentication computer 3 receives the authentication demand. Next, the e-mail authentication computer 3 extracts the settlement amount from the received authentication demand. Next, the e-mail authentication computer 3 generates the authentication demand ID and the authentication e-mail address. Next, after the e-mail authentication computer 3 matches the generated authentication demand ID, the generated authentication e-mail address and the extracted settlement amount, these are memorized in the authentication e-mail address mapping table 341. Next, the e-mail authentication computer 3 sends the generated authentication demand ID and the generated authentication e-mail address to the leader equipment 2110. The leader equipment 2110 receives the authentication demand ID and the authentication e-mail address. Next, the leader equipment 2110 displays the received authentication e-mail address in the display device. The cell phone 60 sends the e-mail to the displayed authentication e-mail address as a start of user operation. The e-mail authentication computer 3 receives the e-mail from the cell phone 60. Next, the e-mail authentication computer 3 acquires the source e-mail address and the destination e-mail address from the received e-mail. Next, after the e-mail authentication computer 3 matches the acquired source e-mail address and the authentication demand ID based on the acquired destination e-mail address, these are memorized in the authentication e-mail address mapping table 341. Specifically, the e-mail authentication computer 3 chooses a record where the authentication e-mail address 3412 of the authentication e-mail address mapping table 341 matches the acquired source e-mail address from the authentication e-mail address mapping table 341. Next, the e-mail authentication computer 3 memorizes the acquired source e-mail address in the user e-mail address 3413 of the chosen record. On the other hand, the leader equipment 2110 sends the authentication result demand to the e-mail authentication computer 3. The e-mail authentication computer 3 receives the authentication result demand from the leader equipment 2110. The e-mail authentication computer 3 extracts the authentication demand ID from the received authentication result demand. Next, the e-mail authentication dedicated-computer 943 chooses a record where the authentication demand ID3411 of the authentication e-mail address mapping table 341 matches the extracted authentication demand ID from the authentication e-mail address mapping table 341. Next, the e-mail authentication computer 3 extracts the user e-mail address 3413 and the settlement amount from the chosen record. Next, the e-mail authentication computer 3 chooses the record where the e-mail address 3422 of the user management table 342 matches the extracted user e-mail address 3413 from the user management table 342. Next, the e-mail authentication computer 3 extracts the credit card number from the chosen record. Next, the e-mail authentication computer 3 does a credit administration for the extracted credit card number. The credit administration is executed by the conventional credit card utility-time. When the credit administration is good, the e-mail authentication computer 3 charges a settlement amount for the credit card. Incidentally, the e-mail authentication computer 3 may demand a credit administration and an accounting for the special equipment. In this case, the e-mail authentication computer 3 is connected with the special equipment which does a credit administration and accounting via the network. When the e-mail authentication computer 3 completes the accounting, it judges authentication to be possible. The e-mail authentication computer 3 sends the result of the authentication to the leader equipment 2110. The leader equipment 2110 receives the authentication result. Then, the leader equipment 2110 displays the received authentication result in the display.

As above-mentioned, a credit card transaction is made of the transformation example of the sixth embodiment even if the user doesn't possess the credit card physically at the store.

Here, the application example of the transformation example of the sixth embodiment of the present invention is described. The e-mail authentication computer 3 which the individual authentication system of the application example of the transformation example of the sixth embodiment is equipped with combines the computer which computes the public utility charges. In other words, the e-mail authentication computer 3 computes the public utility charges, it publishes a bill and it manages payment status. For example, the public utility charges are a phone bill, a cell phone fee, an electricity charges, a gas charge or a water bill and so on. In the sixth embodiment, the e-mail authentication computer 3 matches the e-mail address of cell phone 60 and the credit card number, they are memorized in the user management table 342. In the application example of the transformation example of the sixth embodiment, the user management table 342 of the e-mail authentication computer 3 indicates the match of the e-mail address of cell phone 60 and the identifier of the user who receives the service of the public utility charges. The e-mail authentication computer 3 adds up to the public utility charges instead of charging a settlement amount for the credit card in the store. The user of the leader equipment 2110 possesses the cell phone 60 only and can finish payment in the store.

### Seventh Embodiment

Below, as the individual authentication system of the seventh embodiment, with the individual authentication system of the first embodiment, the example which is connected the company intranet with a personal computer and a PDA (Personal Digital Assistant) are described. The parts which overlap the individual authentication system of the first embodiment use the same mark.

To forward the information communication among the employees while a lot of companies keep the confidentiality of the information on the company, it lays down the company intranet. The employee connects a personal computer or a portable-terminal such as a PDA with the company intranet by the means of communication such as the dialup and VPN to read the company information from outside or to update and to send and receive the e-mail. In the past, the employee enters an user ID and a password to connect the portable-terminal with the company intranet. The user of the personal computer or PDA is authenticated using the authentication way of the first embodiment and connects the portable-terminal with the company intranet. In this case, the client computer 10 is the portable-terminal which tries to be connected with the intranet in the company. Also, the e-mail authentication computer 3 is the administrative server which manages the company intranet. The employee can connect with the company intranet without entering the user ID and the password. Moreover, incidentally, if the second client computer which is different from the portable-terminal sends the e-mail to the e-mail authentication computer 3, the security can be improved. In this case, if the user who tries to connect the portable-terminal with the company intranet doesn't possess the portable-terminal and the second client computer which it is possible to send the e-mail where the source e-mail is the user e-mail address, he can not be authenticated. With this, a stranger who acquired only the portable-terminal can not be authenticated by pretending to the user of the portable-terminal. In other words, even if it supposes that it lost the portable-terminal, the information outflow can be prevented.

### Eighth Embodiment

Below, the example which connects thin client computer with the company server with the individual authentication system of the first embodiment as the individual authentication system of the eighth embodiment is described. The parts which overlap the individual authentication system of the first embodiment use the same mark.

The thin client computer is the personal computer which was equipped with the necessary and minimum auxiliary storage. The company introduces a thin client system to prevent from information outflow such as the burglary or loss of the personal computer. The auxiliary storage of the thin client computer doesn't memorize the enough company data and the application. The company data and the application are memorized by the centering server. The employee operates and connects the thin client computer with the centering server, and the thin client computer reads and updates the company data. If being the past, the employee enters the user ID and the password and connects the thin client computer with the centering server. The user of the thin client computer is authenticated using the authentication way of the first embodiment and connects the thin client computer with the company intranet. In this case, the client computer 10 is the thin client computer which tries to be connected with the centering server. Also, the e-mail authentication computer 3 is the administrative server which manages a connection between the thin client computer and the centering server. The administrative server may be included in the centering server. The employee can connect the thin client computer with the centering server without entering the user ID and the password.

### Ninth Embodiment

Below, as the individual authentication system of the ninth embodiment, with the individual authentication system of the first embodiment, the example which is connected a personal computer and a PDA with the public wireless LAN are described. The parts which overlap the individual authentication system of the first embodiment use the same mark.

The public wireless LAN which gets on the Internet in the outside becomes popular. In the past, the user of the public wireless LAN enters the user ID and the password and connects portable-terminals such as a PDA and the personal computer with the access point of the public wireless LAN. The user of the public wireless LAN is authenticated using the authentication way of the first embodiment and connects the portable-terminal with the access point. In this case, the client computer 10 is the portable-terminal which tries to be connected with the access point. Also, the e-mail authentication computer 3 is the administrative server which manages a connection between the portable-terminal and the access point. The user of the public wireless LAN can connect with the access point without entering the user ID and the password.

### Tenth Embodiment

The individual authentication system of the tenth embodiment is explained below but the parts which overlap the individual authentication system of the first embodiment omit an explanation by using the same mark.

The individual authentication system of the tenth embodiment uses the client ID which is the identifier of the client computer 10 instead of the authentication demand ID. Incidentally, the individual authentication system of the tenth embodiment can be applied to either of the individual authentication system of the first-ninth embodiment and the individual authentication system of the eleventh-fourteenth embodiment. This place describes the case to have applied to the authentication system of the first embodiment.

The individual authentication system in the tenth embodiment is identical with the individual authentication system (FIG. 1) in the first embodiment except for the authentication e-mail address mapping table (FIG. 5) which is memorized at the e-mail authentication computer 3.

FIG. 12 is the schematic of the authentication e-mail address mapping table 20341 which is memorized in the auxiliary storage of the e-mail authentication computer 3 in the tenth embodiment. The authentication e-mail address mapping table 20341 includes a client ID203411, an authentication e-mail address 3412 and an user e-mail address 3413. It omits an explanation because the authentication e-mail address 3412 and user e-mail address 3413 are identical with the one which is included in the authentication e-mail address mapping table (FIG. 5) in the first embodiment. The client ID203411 is the unique identifier of the client computer 10 which an individual authentication system is equipped with. Incidentally, the client ID which is included in the authentication demand which was sent from the client computer 10 is memorized in the client ID203411.

Next, the processing of an individual authentication system in the tenth embodiment is described. Incidentally, it abbreviates an explanation therefore to the processing which is identical with the first embodiment. The client computer 10 sends the authentication demand which includes its own client ID. Then, the e-mail authentication computer 3 allocates an authentication e-mail address for the client ID which is included in the received authentication demand. Next, the e-mail authentication computer 3 memorizes compatible of the client ID which is included in the received authentication demand and the authentication e-mail address which was allocated for the client ID in the authentication e-mail address mapping table 20341. Specifically, the e-mail authentication computer 3 generates newly the e-mail address for the e-mail authentication computer 3 to receive e-mail. Next, the e-mail authentication computer 3 generates a new record in the authentication e-mail address mapping table 20341. Next, the e-mail authentication computer 3 memorizes the client ID which is included in the received authentication demand in the client ID203411 of the newly generated record. Moreover, the e-mail authentication computer 3 memorizes the generated authentication e-mail address in the authentication e-mail address 3412 of the newly generated record.

Next, the e-mail authentication computer 3 sends the generated authentication e-mail address to the client computer 10 via the network 9. The client computer 10 receives the authentication e-mail address from the e-mail authentication computer 3. Next, the client computer 10 displays the received authentication e-mail address in the display device.

The client computer 10 sends e-mail to the authentication e-mail address which was displayed as a start of the user operation. Then, the e-mail authentication computer 3 receives the e-mail from the client computer 10. Next, the source e-mail address and the destination e-mail address are acquired from the received e-mail by the e-mail authentication computer 3. Next, the e-mail authentication computer 3 chooses a record where the authentication e-mail address 3412 of the authentication e-mail address mapping table 20341 matches the acquired destination e-mail address from the authentication e-mail address mapping table 20341. Next, the e-mail authentication computer 3 extracts the client ID203411 from the chosen record. Next, the e-mail authentication computer 3 chooses a record where the e-mail address 3422 of the user management table 342 matches the acquired source e-mail address from the user management table 342. Next, the e-mail authentication computer 3 extracts the user ID 3421 from the chosen record. Then, the e-mail authentication computer 3 judges that the authentication demand which was sent from the client computer 10 identified by extracting the client ID203411 is one by the user who is identified by the extracted user ID 3421. Therefore, the e-mail authentication computer 3 judges whether it authenticates the user who is identified by extracted user ID 3421 or not. Then, the e-mail authentication computer 3 sends the result of the authentication to the client computer 10 which is identified by the extracted client ID203411. Even if the e-mail authentication computer 3 doesn't receive the authentication result demand in this case, the authentication result can be sent to the client computer 10.

Also, to be the following may seem. The e-mail authentication computer 3 receives the e-mail from the client computer 10. Next, the source e-mail address and the destination e-mail address are acquired from the e-mail with the concerned reception by the e-mail authentication computer 3. Next, the e-mail authentication computer 3 chooses the record where the acquired destination e-mail address and the authentication e-mail address 3412 of the authentication e-mail address mapping table 20341 matches from the authentication e-mail address mapping table 20341. Next, the e-mail authentication computer 3 memorizes the acquired source e-mail address in the user e-mail address 3413 of the chosen record.

On the other hand, the client computer 10 sends the authentication result demand which includes its own client ID to the e-mail authentication computer 3. The e-mail authentication computer 3 chooses the record where the client ID203411 of the authentication e-mail address mapping table 20341 matches the client ID which is included in the authentication result demand from the authentication e-mail address mapping table 20341. Next, the e-mail authentication computer 3 extracts the user e-mail address 3413 from the chosen record. Then, the e-mail authentication computer 3 judges an authentication result based on the extracted user e-mail address 3413 like the first embodiment. Specifically, when the user e-mail address 3413 can not be extracted, the e-mail authentication computer 3 judges authentication to be impossible. On the other hand, when the user e-mail address 3413 can be extracted, the e-mail authentication computer 3 chooses a record where the e-mail address 3422 of user management table 342 (FIG. 6) matches the extracted user e-mail address 3413 from the user management table 342. When the e-mail authentication computer 3 can not choose the matching record, it judges authentication to be impossible. On the other hand, when the e-mail authentication computer 3 can choose the matching record, it judges authentication to be possible. With this, the e-mail authentication computer 3 can specify the publisher of the authentication demand. Specifically, the e-mail authentication computer 3 extracts the user ID 3421 from the chosen record. Then, the e-mail authentication computer 3 specifies that the publisher of the authentication demand sent from the client computer 10 which is identified by the client ID included in the authentication result demand is the user who is identified by the extracted user ID 3421. Incidentally, the e-mail authentication computer 3 may include the peculiar information of the user identified by the extracted user ID 3421 in the authentication result. Then, the e-mail authentication computer 3 sends the authentication result to the client computer 10 which is identified by the client included in the authentication result demand via the network 9. Incidentally, the processing except it of the tenth embodiment is identical with the first embodiment. Therefore, it abbreviates an explanation to the identical processing therefore. Incidentally, in this embodiment, instead of the e-mail, it may use the communication of SIP.

Also, in the tenth embodiment of this invention, it may allocate the authentication e-mail address which doesn't overlap for each of all the client computer 10 beforehand. In this case, the correspondence of the client computer 10 and the authentication e-mail address is invariable and it memorizes beforehand at the authentication e-mail address mapping tables 20341 and the like. Then, the e-mail authentication computer 3 can specify the client computer 10 of the source authentication demand based on the source e-mail address.

### Eleventh Embodiment

The individual authentication system of the eleventh embodiment is explained below but the part which overlaps the individual authentication system of the first embodiment omits an explanation by using the same mark.

At the individual authentication system of the eleventh embodiment, the authentication demand ID is omitted. Incidentally, the individual authentication system of the eleventh embodiment can be applied to either of the individual authentication system of the first-tenth embodiment and the individual authentication system of the twelfth-fourteenth embodiment. This place describes the case to have applied to the authentication system of the first embodiment.

Because the e-mail authentication computer 3 in the eleventh embodiment is identical with the one which the individual authentication system in the first embodiment is equipped with except for the authentication e-mail address mapping table 341, it omits an explanation.

FIG. 13 is the schematic of the authentication e-mail address mapping table 341 which is memorized in the auxiliary storage device 34 of the e-mail authentication computer 3 in the eleventh embodiment. The authentication e-mail address mapping table 341 in the eleventh embodiment is identical with the e-mail address mapping table (FIG. 5) in the first embodiment except for the point which the authentication demand ID3411 was abbreviated to.

Next, the processing of the individual authentication way of the eleventh embodiment is described using the figure. FIG. 14 is the sequence chart of the processing of the individual authentication way of the eleventh embodiment.

The client computer 10 sends an authentication e-mail address acquiring demand to the e-mail authentication computer 3 via the network 9 (ST111) as a start of user operation.

The e-mail authentication computer 3 receives the authentication e-mail address acquiring demand from the client computer 10 (ST112). Then, the e-mail authentication computer 3 generates an authentication e-mail address (ST114).

Next, the e-mail authentication computer 3 sends the generated authentication e-mail address to the client computer 10 via the network 9 (ST20116).

The client computer 10 receives the authentication e-mail address from the e-mail authentication computer 3 (ST20117).

The client computer 10 sends the e-mail directing to the authentication e-mail address via the network 9 as a start of user operation (ST118).

Then, the e-mail authentication computer 3 receives the e-mail from the client computer 10 (ST119). Next, the e-mail authentication computer 3 acquires the source e-mail address and the destination e-mail address from the received e-mail. Next, the e-mail authentication computer 3 creates a new record in the authentication e-mail address mapping table 341. Next, the e-mail authentication computer 3 memorizes the acquired destination e-mail address in the authentication e-mail address 3412 of the new record. Next, the e-mail authentication computer 3 memorizes the acquired source e-mail address in the user e-mail address 3413 of the new record (ST20120).

On the one hand, the client computer 10 sends the authentication demand which includes the received authentication e-mail address to the e-mail authentication computer 3 via the network 9 (ST20121). Incidentally, the client computer 10 may send the authentication demand as a start of user operation and may send the authentication demand every constant time.

Then, the e-mail authentication computer 3 receives the authentication demand from the client computer 10 (ST20122). Next, the authentication e-mail address is acquired from the received authentication demand by the e-mail authentication computer 3. Next, the e-mail authentication computer 3 chooses a record where the authentication e-mail address 3412 of the authentication e-mail address mapping table 341 matches the acquired authentication e-mail address from the authentication e-mail address mapping table 341. Continuously, the e-mail authentication computer 3 extracts the user e-mail address 3413 from the chosen record. Incidentally, if the user e-mail address 3413 can not be extracted, the e-mail authentication computer 3 judges authentication to be impossible. On the other hand, the e-mail authentication computer 3 chooses the record where the e-mail address 3422 of the user management table 342 (FIG. 6) matches the extracted user e-mail address 3413 from the user management table 342 (ST20123). When the e-mail authentication computer 3 can not extracted the matching record from the user management table 342, it judges authentication to be impossible.

On the one hand, when the e-mail authentication computer 3 can choose the matching record, it judges authentication to be possible. With this, the e-mail authentication computer 3 can specify the publisher of the authentication demand. Specifically, the e-mail authentication computer 3 extracts the user ID 3421 from the chosen record. Then, the e-mail authentication computer 3 specifies the publisher of the received authentication demand as the user who is identified by the extracted user ID 3421

Next, the e-mail authentication computer 3 sends the authentication result to the client computer 10 via the network 9 (ST124). Incidentally, the e-mail authentication computer 3 may send the peculiar information of the user to match the extracted user ID 3421 to the client computer 10 with the authentication result.

Then, the client computer 10 receives the authentication result from the e-mail authentication computer 3 (ST125).

The e-mail authentication computer 3 in the individual authentication system of the eleventh embodiment generates an authentication e-mail address. However, the client computer 10 may generate an authentication e-mail address.

In this case, the e-mail authentication computer 3 sends an authentication e-mail address creation information to the client computer 10 instead of the authentication e-mail address. The authentication e-mail address creation information is the information for the client computer 10 to generate an authentication e-mail address.

For example, the authentication e-mail address creation information is the client side program which was described in Java (the registered trademark) Script.

The client computer 10 generates an authentication e-mail address based on the received authentication e-mail address creation information. For example, the client computer 10 generates the authentication e-mail address using at least one out of the time and the random number.

Incidentally, the generated authentication e-mail address is bad if it isn't unique. Therefore, the number of the character strings of the authentication e-mail address which is generated by the client computer 10 is decided according to the number of the users who is authenticated in fixed time.

Incidentally, the authentication e-mail address acquiring demand in the eleventh embodiment corresponds to the authentication demand in the first-tenth embodiment. Also, the authentication demand in the eleventh embodiment corresponds to the authentication result demand in the 1-10th embodiment.

### Twelfth Embodiment

The individual authentication system of the twelfth embodiment is explained below but the part which overlaps the individual authentication system of the first embodiment omits an explanation by using the same mark.

The individual authentication system of the twelfth embodiment uses the authentication demand ID instead of the authentication e-mail address. Also, instead of the authentication e-mail address, the client ID may be used. Incidentally, the individual authentication system of the twelfth embodiment can be applied to either of the individual authentication system of the first-eleventh embodiment and the individual authentication system of thirteenth-fourteen embodiment. This place describes the case to have applied to the authentication system of the first embodiment.

Because the e-mail authentication computer 3 in of the twelfth embodiment is identical with the one which an individual authentication system in the first embodiment is equipped with except for the authentication e-mail address mapping table 341, it omits an explanation.

FIG. 15 is the schematic of the authentication e-mail address mapping table 341 which is memorized in the auxiliary storage device 34 of the e-mail authentication computer 3 in the twelfth embodiment. The authentication e-mail address mapping table 341 in the twelfth embodiment is identical with the e-mail address mapping table (FIG. 5) in the first embodiment except for the point which the authentication e-mail address 3412 was abbreviated to.

Next, the processing of the individual authentication way of the twelfth embodiment is described using figure. FIG. 16 is the sequence chart of the processing of the individual authentication way of the twelfth embodiment.

The client computer 10 sends an authentication demand ID acquiring demand to the e-mail authentication computer 3 via the network 9 (ST111) as a start of the user operation.

The e-mail authentication computer 3 receives the authentication demand ID acquiring demand from the client computer 10 (ST112). Then, the e-mail authentication computer 3 generates an authentication demand ID (ST113). Next, the e-mail authentication computer 3 sends the e-mail address for the e-mail authentication computer 3 to receive e-mail and the generated authentication demand ID to the client computer 10 via the network 9 (ST30116).

The client computer 10 receives the authentication demand ID and the e-mail address from the e-mail authentication computer 3 (ST30117).

The client computer 10 sends the e-mail which includes the authentication demand ID via the network 9 as a start of the user operation (ST30118). Incidentally, the destination e-mail address may be whatever one if it is the e-mail address which was received from the e-mail authentication computer 3 and the destination e-mail address is the e-mail address for the e-mail authentication computer 3 to receive e-mail. Also, the authentication demand ID which is included in the e-mail may be specified in either of this passage, the title or the attachment file. Moreover, the authentication demand ID which is included in the e-mail may be encrypted.

Then, the e-mail authentication computer 3 receives the e-mail from the client computer 10 (ST3019). Next, the source e-mail address and the authentication demand ID are acquired from the received e-mail by the e-mail authentication computer 3. Next, the e-mail authentication computer 3 creates a new record in the authentication e-mail address mapping table 341. Next, the e-mail authentication computer 3 memorizes the acquired authentication demand ID in the authentication demand ID3411 of the new record. Next, the e-mail authentication computer 3 memorizes the acquired source e-mail address in the user e-mail address 3413 of the new record (ST30120).

On the one hand, the client computer 10 sends the authentication demand which includes the received authentication demand ID to the e-mail authentication computer 3 via the network 9 (ST121). Incidentally, the client computer 10 may send an authentication demand as a start of the user operation or every constant time.

Then, the e-mail authentication computer 3 receives the authentication demand from the client computer 10 (ST122). Next, the e-mail authentication computer 3 acquires the authentication demand ID from the received authentication demand. Next, the e-mail authentication computer 3 chooses the record where the authentication demand ID3411 of the authentication e-mail address mapping table 341 matches the acquired authentication demand ID from the authentication e-mail address mapping table 341. Continuously, the e-mail authentication computer 3 extracts the user e-mail address 3413 from the chosen record. Incidentally, when the user e-mail address 3413 can not be extracted, the e-mail authentication computer 3 judges authentication to be impossible. On the other hand, the e-mail authentication computer 3 chooses the record where the e-mail address 3422 of the user management table 342 (FIG. 6) matches the extracted user e-mail address 3413 from the user management table 342 (ST30123). When the e-mail authentication computer 3 can not extract a matching record from the user management table 342, it judges authentication to be impossible.

On the one hand, when the e-mail authentication computer 3 can choose a matching record, it judges authentication to be possible. With this, the e-mail authentication computer 3 can specify the publisher of the authentication demand. Specifically, the e-mail authentication computer 3 extracts the user ID 3421 from the chosen record. Then, the e-mail authentication computer 3 specifies the publisher of the authentication demands which is identified by the acquired authentication demand ID as a user who is identified by the extracted user ID 342.

Next, the e-mail authentication computer 3 sends the authentication result to the client computer 10 via the network 9 (ST124). Incidentally, the e-mail authentication computer 3 may send the peculiar information of the user to match the extracted user ID 3421 to the client computer 10 with the authentication result.

Then, the client computer 10 receives the authentication result from the e-mail authentication computer 3 (ST125).

The e-mail authentication computer 3 in the individual authentication system of the twelfth embodiment generates a authentication demand ID. However, the client computer 10 may generate the authentication demand ID. In this case, the e-mail authentication computer 3 sends the authentication demand ID creation information to the client computer 10 instead of the authentication demand ID. The authentication demand ID creation information is the information for the client computer 10 to generate the authentication demand ID. For example, the authentication demand ID creation information is the client side program which was described in Java (the registered trademark) Script. The client computer 10 generates the authentication demand ID based on the received authentication demand ID creation information. For example, the client computer 10 generates the authentication demand ID using at least one out of the time and the random number. Incidentally, the generated authentication demand ID is bad if it isn't unique. Therefore, the number of the character strings of the authentication e-mail address which is generated by the client computer 10 is decided according to the number of the users who is authenticated in fixed time. Incidentally, the authentication demand ID acquiring demand in the twelfth embodiment matches the authentication demand in the first-tenth embodiment. Also, the authentication demand in the twelfth embodiment matches to the authentication result demand in the first-tenth embodiment.

### Thirteenth Embodiment

The individual authentication system of the thirteenth embodiment is explained below but the part which overlaps the individual authentication system of the first embodiment omits an explanation by using the same mark.

In the individual authentication system of the thirteenth embodiment, the e-mail authentication computer 3 generates an authentication e-mail address. However, in the individual authentication system of the thirteenth embodiment, the client computer 10 generates an authentication e-mail address. The individual authentication system of the thirteenth embodiment can be applied to either of the individual authentication system of the first-twelfth embodiment and the individual authentication system of the fourteenth embodiment. This place describes the case to have applied to the authentication system of the first embodiment.

The client computer 10 of the thirteenth embodiment is described. This place describes the point that the client computer 10 in the thirteenth embodiment is characteristic more than the client computer 10 in the first embodiment.

The client computer 10 sends an authentication e-mail address creation information acquiring demand to the e-mail authentication computer 3 as a start of the user operation. Then, the client computer 10 receives the authentication e-mail address creation information from the e-mail authentication computer 3. The authentication e-mail address creation information is the information for the client computer 10 to generate an authentication e-mail address. For example, it is the client side program which was described in Java (the registered trademark) Script. Incidentally, the authentication e-mail address creation information includes a domain for the e-mail authentication computer 3 to receive the e-mail. Also, the authentication e-mail address creation information may be beforehand memorized in the client computer 10. The client computer 10 generates an authentication e-mail address based on the received authentication e-mail address creation information. For example, the client computer 10 generates the authentication e-mail address using at least one out of the time and the random number. Incidentally, the generated authentication e-mail address must be unique. Therefore, the number of the character strings of the authentication e-mail address which is generated by the client computer 10 is decided according to the number of the users who is authenticated in fixed time.

The client computer 10 sends the authentication demand which includes the part or all of the generated e-mail address to the e-mail authentication computer 3. The opportunity of the sending of the authentication demand is the completion of the generation of the authentication e-mail address and the like.

Next, the e-mail authentication computer 3 in the thirteenth embodiment is described. This place describes the point that the e-mail authentication computer 3 in the thirteenth embodiment is characteristic more than the e-mail authentication computer 3 in the first embodiment.

The e-mail authentication computer 3 receives the authentication e-mail address creation information acquiring demand from the client computer 10. Then, the e-mail authentication computer 3 sends the authentication e-mail address creation information to the client computer 10.

The e-mail authentication computer 3 receives the authentication demand which includes the authentication e-mail address from the client computer 10. Next, the e-mail authentication computer 3 generates the authentication demand ID which identifies the received authentication demand uniquely. Then, the authentication e-mail address which is included in the received authentication demand and the generated authentication demand ID are corresponded by the e-mail authentication computer 3 and these are memorized in the authentication e-mail address mapping table 341. Also, the e-mail authentication computer 3 sends the generated authentication demand ID to the client computer 10.

Next, the processing of the individual authentication way of the thirteenth embodiment is described.

The client computer 10 sends the authentication e-mail address creation information acquiring demand to the e-mail authentication computer 3 as a start of the user operation.

The e-mail authentication computer 3 receives the authentication e-mail address creation information acquiring demand from the client computer 10. Then, the e-mail authentication computer 3 sends the authentication e-mail address creation information to the client computer 10.

The client computer 10 receives the authentication e-mail address creation information from the e-mail authentication computer 3. Then, the client computer 10 generates the authentication e-mail address. Next, the client computer 10 sends the authentication demand which includes the part or all of the generated authentication e-mail address to the e-mail authentication computer 3.

The e-mail authentication computer 3 receives the authentication demand from the client computer 10. Next, the e-mail authentication computer 3 generates the authentication demand ID. Then, the authentication e-mail address which is included in the received authentication demand and the generated authentication demand ID are correspond by the e-mail authentication computer 3 and these are memorized in the e-mail authentication computer 3. Also, the e-mail authentication computer 3 sends the generated authentication demand ID to the client computer 10.

The client computer 10 receives the authentication demand ID from the e-mail authentication computer 3. Then, the client computer 10 displays the generated authentication e-mail address in the display device.

Incidentally, in the individual authentication system of the thirteenth embodiment like the individual authentication system in the first embodiment, the authentication e-mail address may be used as the identifier to identify an authentication demand. In this case, the authentication demand ID is omitted. Therefore, the e-mail authentication computer 3 doesn't generate an authentication demand ID. Then, the e-mail authentication computer 3 memorizes only the authentication e-mail address which was received from the client computer 10 in the authentication e-mail address mapping table 341. Also, the e-mail authentication computer 3 doesn't send the authentication demand ID to the client computer 10.

Here, it returns to the explanation of the processing of the individual authentication way of the thirteenth embodiment. Incidentally, the processing since then is the same as the individual authentication way of the first embodiment.

The client computer 10 or the second client computer sends the e-mail directing to the authentication e-mail address as a start of the user operation.

The e-mail authentication computer 3 receives the e-mail. Next, the source e-mail address and the destination e-mail address are acquired from the received e-mail by the e-mail authentication computer 3. Next, the e-mail authentication computer 3 chooses a record where the e-mail address 3412 of the authentication e-mail address mapping table 341 matches the acquired destination e-mail address from the authentication e-mail address mapping table 341. Next, the e-mail authentication computer 3 memorizes the acquired source e-mail address in the user e-mail address 3413 of the chosen record. The e-mail authentication computer 3 means to manage a source e-mail address of the received e-mail and a destination e-mail address of the received e-mail. In other words, the e-mail authentication computer 3 is managing the received e-mail.

On the one hand, the client computer 10 sends the authentication result demand which includes the received authentication demand ID to the e-mail authentication computer 3. Incidentally, the client computer 10 may send the authentication result demand as a start of the user operation or every constant time.

Then, the e-mail authentication computer 3 receives the authentication result demand from the client computer 10. When the e-mail authentication computer 3 receives the authentication result demand, it acquires the authentication demand ID from the received authentication result demand. Next, the e-mail authentication computer 3 chooses the record where the authentication demand ID3411 of the authentication e-mail address mapping table 341 matches the acquired authentication demand ID from the authentication e-mail address mapping table 341. Continuously, the e-mail authentication computer 3 extracts the user e-mail address 3413 from the chosen record. Incidentally, if the user e-mail address 3413 can not be extracted, the e-mail authentication computer 3 judges authentication to be impossible. On the other hand, the e-mail authentication computer 3 chooses a record where the e-mail address 3422 of the user management table 342 matches the extracted user e-mail address 3413 from the user management table 342. When the matching record can not be chosen from the user management table 342, the e-mail authentication computer 3 judges it authentication to be impossible. On the one hand, when a matching record can be chosen, the e-mail authentication computer 3 judges it authentication to be possible. Then, the e-mail authentication computer 3 sends the authentication result to the client computer 10. At this time, the e-mail authentication computer 3 may send the other peculiar information managed in the user management table 342 with the authentication result.

The client computer 10 receives the authentication result from the e-mail authentication computer 3.

Incidentally, when not using an authentication demand ID in the individual authentication system in the thirteenth embodiment, the client computer 10 sends the authentication result demand which includes the part or all of the authentication e-mail address to the e-mail authentication computer 3.

As above-mentioned, the user of the client computer 10 can be authenticated without entering an user ID and a password.

In the individual authentication system in the thirteenth embodiment, an authentication e-mail address isn't generated by one piece of the e-mail authentication computer 3 and is generated by more than one piece of the client computer 10. Therefore, the load to the CPU of the e-mail authentication computer 3 in the individual authentication system of the thirteenth embodiment is light compared with the load to the CPU of the e-mail authentication computer 3 in the individual authentication system of the first embodiment. Therefore, the e-mail authentication computer 3 in the individual authentication system of the thirteenth embodiment can authenticate more users in fixed time.

Next, a thirteenth transformed embodiment is described. The e-mail authentication computer 3 in the individual authentication system of the thirteenth embodiment generates an authentication demand ID. However, the client computer 10 may generate an authentication demand ID. In this case, the client computer 10 receives an authentication demand ID creation information with the authentication e-mail address creation information from the e-mail authentication computer 3. The authentication demand ID creation information is the information to generate the authentication demand ID. For example, the authentication demand ID creation information is the client side program which was described in Java (the registered trademark) Script. The e-mail authentication computer 3 generates an authentication e-mail address based on the authentication e-mail address creation information. Like this, the e-mail authentication computer 3 generates the authentication demand ID based on the authentication demand ID creation information. The client computer 10 sends the generated authentication e-mail address and the generated authentication demand ID to the e-mail authentication computer 3. The e-mail authentication computer 3 receives the authentication e-mail address and the authentication demand ID. Then, the received authentication e-mail address and the received authentication demand ID are corresponded by the e-mail authentication computer 3 and these are memorized in the authentication e-mail address mapping table 341. The processing since then is same as the thirteenth embodiment which was above-mentioned.

Also, it used e-mail for this embodiment but UA (the user agent) may be used as the protocol and the like which are composed of the address form which is the same as the e-mail and so on. For example, this protocol is SIP (SESSION INITIATION PROTOCOL).

### Fourteenth Embodiment

The individual authentication system of the fourteenth embodiment is explained below but the part which overlaps the individual authentication system of the fifth embodiment omits an explanation by using the same mark.

In the individual authentication system of the fifth embodiment, the ATM e-mail authentication computer 923 generates an authentication e-mail address. However, in the individual authentication system of the fourteenth embodiment, the ATM2010 generates an authentication e-mail address. Incidentally, this place describes the case to use ATM_ID instead of the authentication demand ID.

The ATM2010 of the fourteenth embodiment is described. This place describes the point that the ATM2010 in the fourteenth embodiment is characteristic more than the ATM2010 in the fifth embodiment.

The ATM2010 generates an authentication e-mail address as a start of the user operation. Then, the ATM2010 sends the ATM_ID and the generated authentication e-mail address to the authentication server.

Next, the ATM e-mail authentication computer 923 of the fourteenth embodiment is described. This place describes the point that the ATM e-mail authentication computer 923 in the fourteenth embodiment is characteristic more than the ATM e-mail authentication computer 923 in the fifth embodiment.

The ATM e-mail authentication computer 923 receives the ATM_ID and the authentication e-mail address from the ATM2010. Then, the received ATM_ID and the received authentication e-mail address are corresponded by the ATM e-mail authentication computer 923 and these are memorized in the authentication e-mail address mapping table 341.

Next, the processing of the individual authentication way of the fourteenth embodiment is described.

The ATM2010 generates an authentication e-mail address as a start of the user operation. Then, the ATM2010 sends the generated authentication e-mail address and the ATM_ID to the ATM e-mail authentication computer 923. Also, ATM2010 displays the generated authentication e-mail address in the display device. Now, the ATM2010 changes the generated authentication e-mail address into the QR code and so on and may display it.

The ATM e-mail authentication computer 923 receives the authentication e-mail address and the ATM_ID. Continuously, the received authentication e-mail address and the received ATM_ID are corresponded by the ATM e-mail authentication computer 923 and these are memorized in the authentication e-mail address mapping table 341.

The Cell phone 2060 sends the e-mail to the ATM e-mail authentication computer 923 as a start of the user operation. The destination e-mail address of the e-mail is the e-mail address which was displayed in the ATM2010.

The ATM e-mail authentication computer 923 receives the e-mail from the ATM2010. Next, the source e-mail address and the destination e-mail address are acquired from the received e-mail by the ATM e-mail authentication computer 923. Next, the ATM e-mail authentication computer 923 chooses the record where the e-mail address 3412 of the authentication e-mail address mapping table 341 matches the acquired source e-mail address from the authentication e-mail address mapping table 341. Next, the ATM e-mail authentication computer 923 extracts the ATM_ID from the chosen record.

Next, the ATM e-mail authentication computer 923 chooses a record where the e-mail address 3422 of user management table 342 matches the acquired source e-mail address from the user management table 342. When the matching record can not be chosen from the user management table 342, the ATM e-mail authentication computer 923 judges it authentication to be impossible. On the one hand, when the matching record can be chosen, ATM e-mail authentication computer 923 judges it authentication to be possible. Then, the ATM e-mail authentication computer 923 sends the authentication result to the ATM2010 which is identified by the extracted ATM ID.

The ATM2010 receives the authentication result from the ATM e-mail authentication computer 923.

As above-mentioned, the user of ATM2010 can receive an individual authentication without entering an user ID and a password.

In the individual authentication system of the fourteenth embodiment, an authentication e-mail address isn't generated by one piece of the ATM e-mail authentication computer 923 but is generated by the plural ATMs 2010. Therefore, the load to the CPU of the ATM e-mail authentication computer 923 in the individual authentication system of the fourteenth embodiment is light compared with the load to the CPU of the e-mail authentication computer 3 in the individual authentication system of the fifth embodiment. Therefore, the e-mail authentication computer 3 in the individual authentication system of the fourteenth embodiment can authenticate more users in the fixed time.

Also, it used e-mail in this embodiment but UA (the user agent) may be used as the protocol and the like which are composed of the address form which is the same as the e-mail and so on. For example, this protocol is SIP (SESSION INITIATION PROTOCOL).

Futures of the individual authentication system of the thirteenth embodiment and the fourteenth embodiment is explained below. An authentication computer comprising a processor, a memory and an interface: wherein the authentication computer is coupled to plural client computers via a network; wherein the memory memorizes an user information which includes a correspondence relation between an user and an e-mail address of the user; wherein the processor receives an authentication e-mail address, the authentication e-mail address is an e-mail address used for authentication, the authentication e-mail address is an e-mail address for the authentication computer to receive an e-mail; wherein the processor receives an e-mail; wherein the processor receives an authentication result demand from the client computer; wherein the processor specifies the authentication e-mail address corresponded the received authentication result demand; wherein the processor specifies the e-mail where a destination e-mail address is the specified authentication e-mail address among the received e-mails; wherein the processor specifies a source e-mail address from the specified e-mail; wherein the processor refers to the user information to specify the user corresponded to the specified source e-mail address; and wherein the processor sends data corresponded to the specified user to the client computer which sent the received authentication result demand.

An authentication computer comprising a processor, a memory and an interface: wherein the authentication computer is coupled to plural client computers via a first network; wherein the authentication computer is coupled to plural e-mail sending computers via a second network; wherein the memory memorizes an user information which includes a correspondence relation between an user and an e-mail address of the user; wherein the processor receives an authentication e-mail address from the client computer via the first network, the authentication e-mail address is an e-mail address used for authentication, the authentication e-mail address is an e-mail address for the authentication computer to receive an e-mail; wherein the processor receives an e-mail from the e-mail sending computer via the second network; wherein the processor specifies a destination e-mail address and a source e-mail address from the received e-mail; wherein the processor refers to the user information to specify the user corresponded to the specified source e-mail address; wherein the processor specifies the client computer which sent the specified destination e-mail address as the authentication e-mail address; and wherein the processor sends data corresponded to the specified user to the specified client computer via the first network.

The processor specifies the authentication e-mail address corresponded the received authentication result demand based on a correspondence relation between a communication for the authentication e-mail address and a communication for the authentication result demand. The processor gives an identifier to the communication for the authentication e-mail address. The processor specifies the correspondence relation between the communication for the authentication e-mail address and the communication for the authentication result demand based on the identifier included in the authentication result demand.

The authentication computer is coupled to an e-mail sending computer. The processor receives the e-mail from the client computer or the e-mail sending computer.

The processor sends an authentication e-mail address creation information to the client computer 10. The authentication e-mail address creation information is information for the client computer 10 to generate an authentication e-mail address.

An authentication computer comprising a processor, a memory and an interface: wherein the authentication computer is coupled to plural client computers via a network; wherein the memory memorizes an user information which includes a correspondence relation between an user and an user agent address of the user; wherein the processor receives an authentication user agent address, the authentication user agent address is an user agent address used for authentication, the authentication user agent address is an user agent address for the authentication computer to receive a signaling; wherein the processor receives a signaling; wherein the processor receives an authentication result demand from the client computer; wherein the processor specifies the authentication user agent address corresponded the received authentication result demand; wherein the processor specifies the signaling where a destination user agent address is the specified authentication user agent address among the received signalings; wherein the processor specifies a source user agent address from the specified signaling; wherein the processor refers to the user information to specify the user corresponded to the specified source user agent address; and wherein the processor sends data corresponded to the specified user to the client computer which sent the received authentication result demand.

An authentication computer comprising a processor, a memory and an interface: wherein the authentication computer is coupled to plural client computers via a first network; wherein the authentication computer is coupled to plural signaling sending computers via a second network; wherein the memory memorizes an user information which includes a correspondence relation between an user and an user agent address of the user; wherein the processor receives an authentication user agent address from the client computer via the first network, the authentication user agent address is an user agent address used for authentication, the authentication user agent address is an user agent address for the authentication computer to receive a signaling; wherein the processor receives a signaling from the signaling sending computer via the second network; wherein the processor specifies a destination user agent address and a source user agent address from the received signaling; wherein the processor refers to the user information to specify the user corresponded to the specified source user agent address; wherein the processor specifies the client computer which sent the specified destination user agent address as the authentication user agent address; and wherein the processor sends data corresponded to the specified user to the specified client computer via the first network.

The processor specifies the authentication user agent address corresponded the received authentication result demand based on a correspondence relation between a communication for the authentication user agent address and a communication for the authentication result demand.

The processor gives an identifier to the communication for the authentication user agent address. The processor specifies the correspondence relation between the communication for the authentication user agent address and the communication for the authentication result demand based on the identifier included in the authentication result demand.

The authentication computer is coupled to a signaling sending computer. The processor receives the signaling from the client computer or the signaling sending computer.

The processor sends an authentication user agent address creation information to the client computer 10. The authentication user agent address creation information is information for the client computer 10 to generate an authentication user agent address.

By utilizing representative embodiment of present invention, the security and convenient of personal authentication system are enhanced.

### BRIEF DESCRIPTION OF THE DRAWINGS

FIG. 1 shows a compositional outline figure about a personal authentication system of the first embodiment.

FIG. 2 shows structural block figure of the client computer 10 equipped with the personal authentication system of the first embodiment.

FIG. 3 is the block diagram of the composition of the e-mail authentication computer 3 that the personal authentication system of the first embodiment is equipped with.

FIG. 4 is the functional block diagram of the e-mail authentication computer 3 of the first embodiment.

FIG. 5 is the schematic of the authentication e-mail address mapping table 341 which is memorized in the auxiliary storage device 34 of the e-mail authentication computer 3 of the first embodiment.

FIG. 6 is the schematic of the user management table 342 which is memorized in the auxiliary storage device 34 of the e-mail authentication computer 3 of the first embodiment.

FIG. 7 is the sequence chart of the processing of the individual authentication way of the first embodiment.

FIG. 8 is the schematic of the outline of the individual authentication system of the third embodiment.

FIG. 9 is the sequence chart of the processing of the individual authentication way of the third embodiment.

FIG. 10 is the schematic of the outline of the individual authentication system of the fifth embodiment.

FIG. 11 is the schematic of the outline of the individual authentication system of the sixth embodiment.

FIG. 12 is the schematic of the authentication e-mail address mapping table 20341 which is memorized in the auxiliary storage of the e-mail authentication computer 3 in the tenth embodiment.

FIG. 13 is the schematic of the authentication e-mail address mapping table 341 which is memorized in the auxiliary storage device 34 of the e-mail authentication computer 3 in the eleventh embodiment.

FIG. 14 is the sequence chart of the processing of the individual authentication way of the eleventh embodiment.

FIG. 15 is the schematic of the authentication e-mail address mapping table 341 which is memorized in the auxiliary storage device 34 of the e-mail authentication computer 3 in the twelfth embodiment.

FIG. 16 is the sequence chart of the processing of the individual authentication way of the twelfth embodiment.

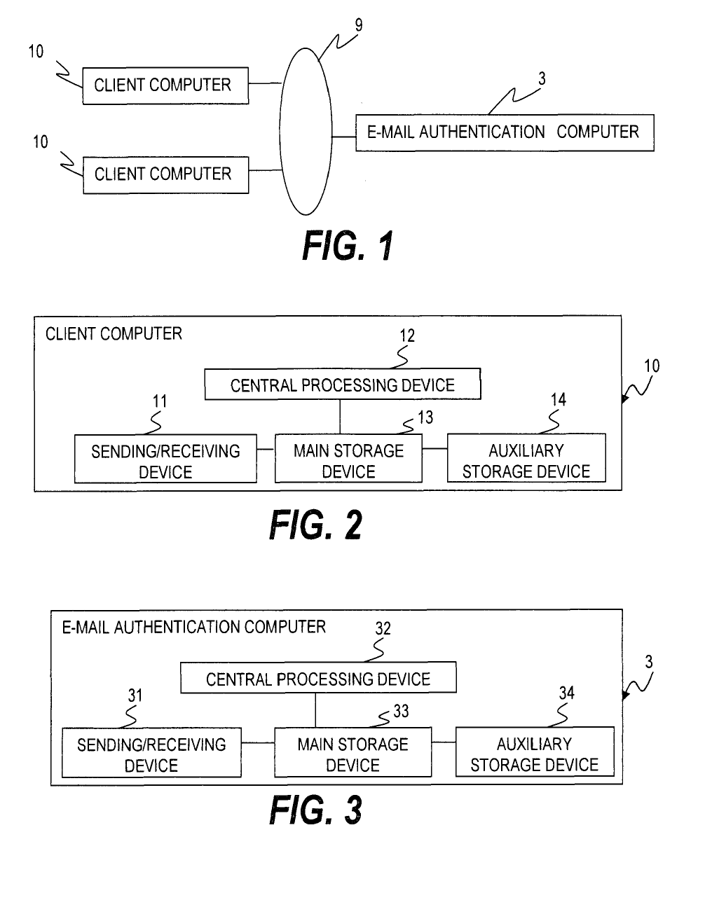

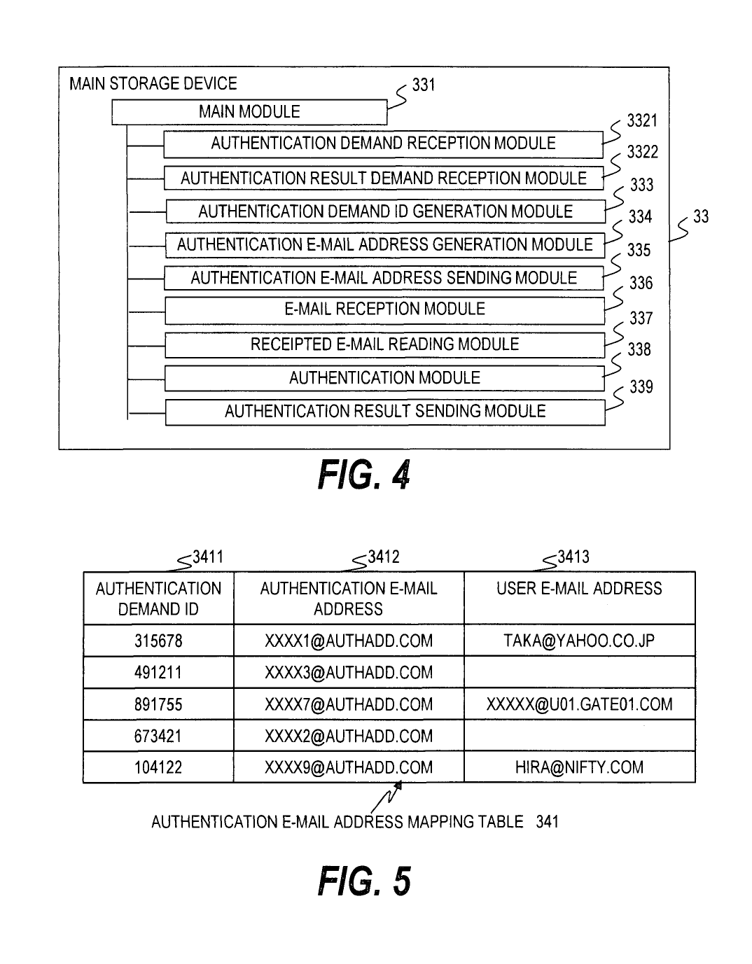

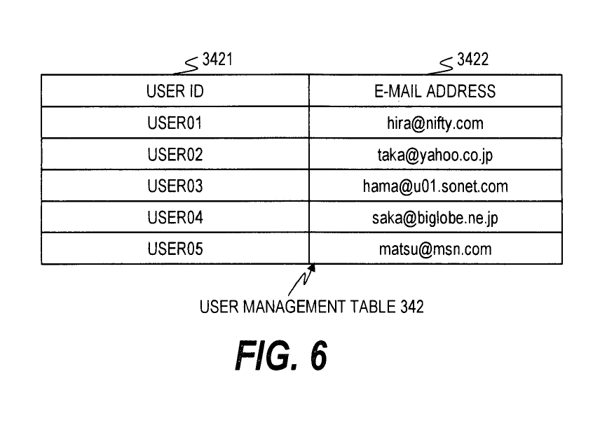

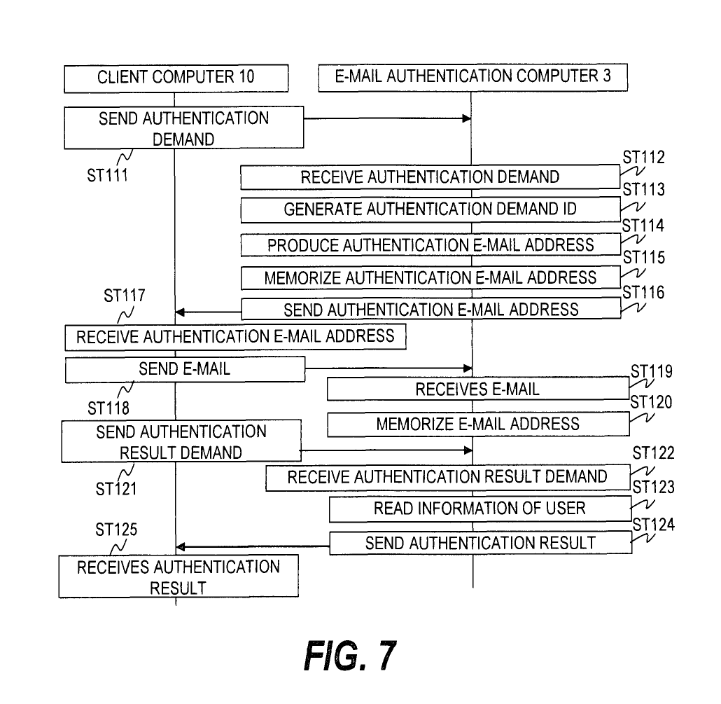

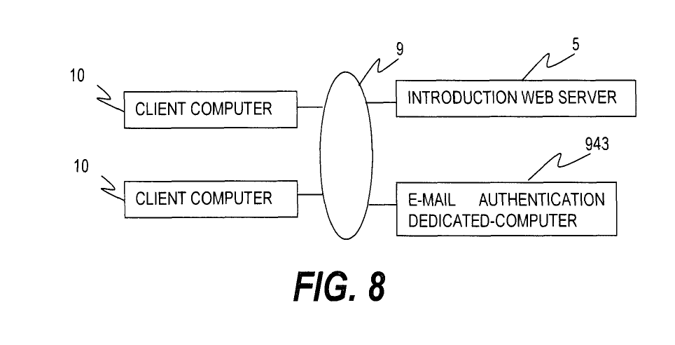

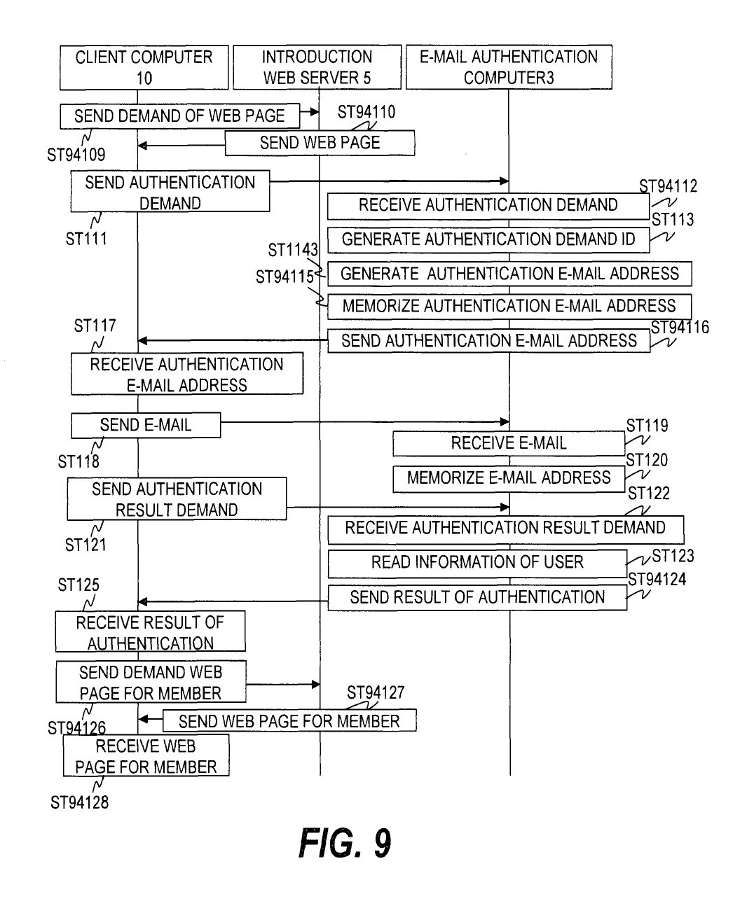

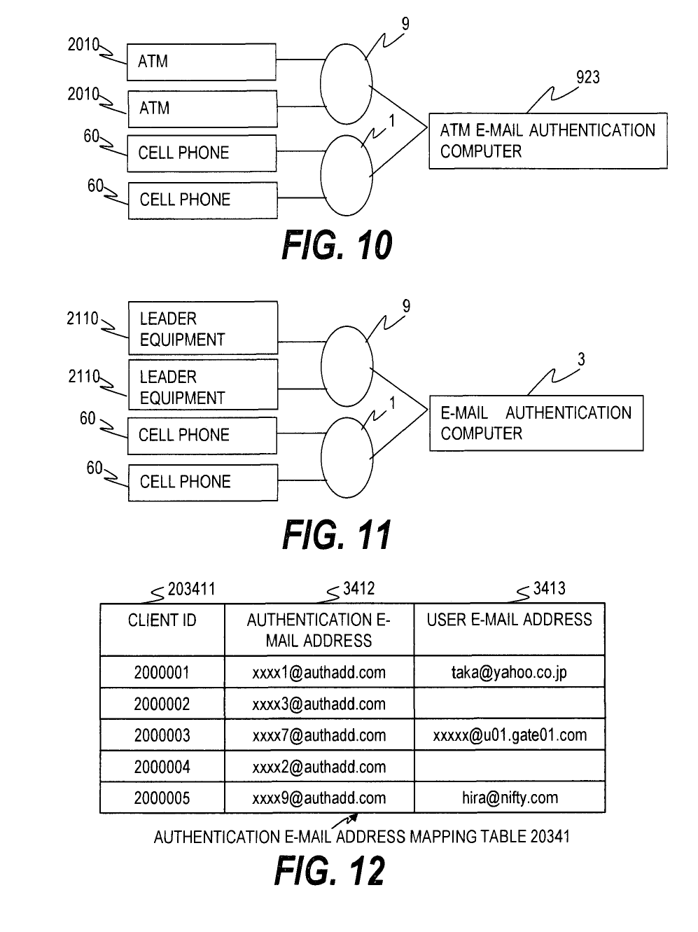

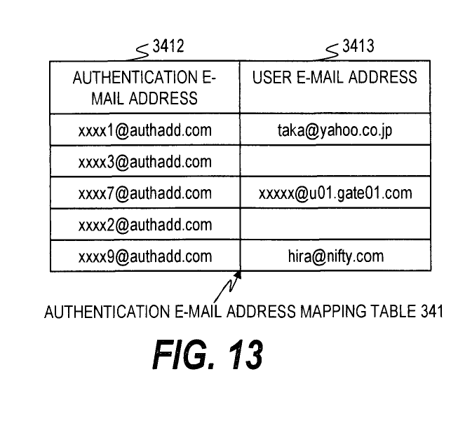

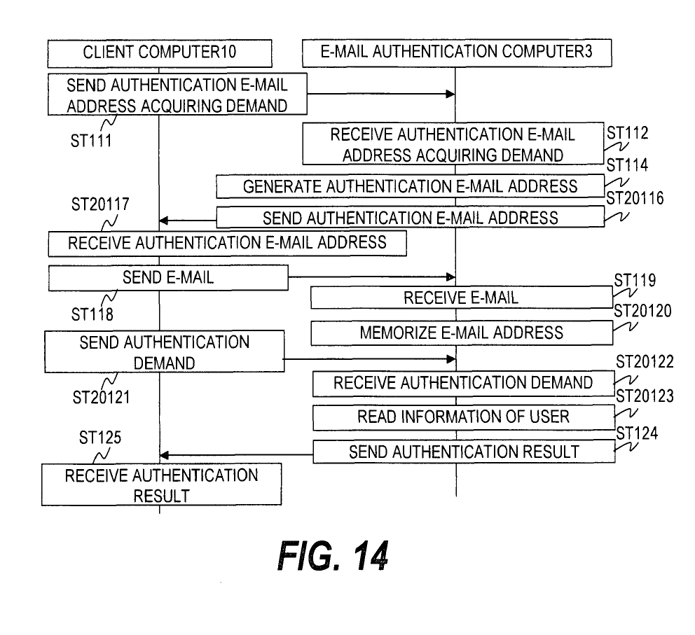

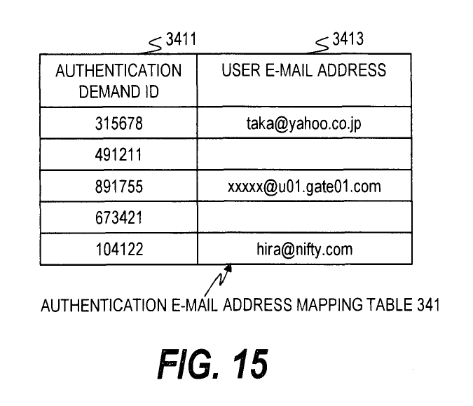

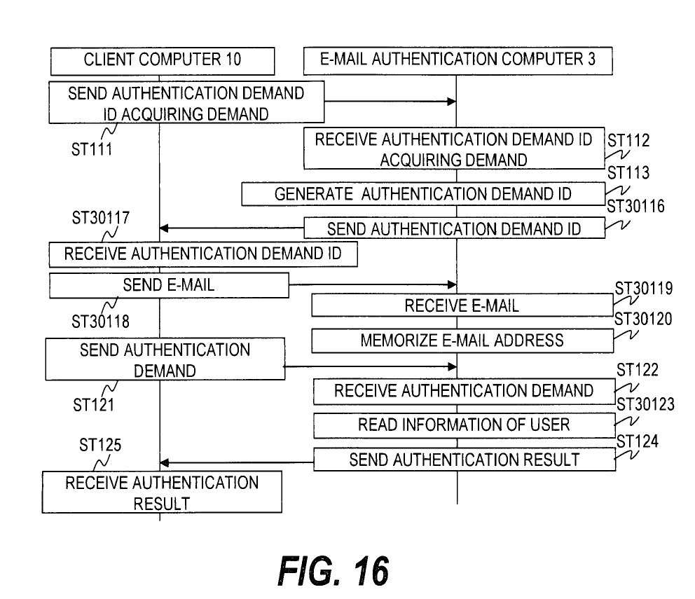

### REFERENCE NUMERALS

1 Internet
3 e-mail authentication computer
5 introduction WEB server
9 network
10 client computer
11 sending/receiving device
12 central processing device
13 main storage device
14 auxiliary storage device
31 sending/receiving device
32 central processing device
33 main storage device
34 auxiliary storage device
60 cell phone
300 authentication program
331 main module
333 authentication demand ID generation module
334 authentication e-mail address generation module
335 authentication e-mail address sending module
336 e-mail reception module
337 receipted e-mail reading module
338 authentication module
339 authentication result sending module
341 authentication e-mail address mapping table
342 user management table
903 e-mail authentication computer
923 ATM e-mail authentication computer
943 e-mail authentication dedicated-computer
2010 ATM
2060 cell phone
2110 leader equipment
3321 authentication demand reception module
3322 authentication result demand reception module
3411 authentication demand ID
3412 authentication e-mail address
3413 user e-mail address
3421 user ID
3422 e-mail address
20341 authentication e-mail address mapping table
203411 client ID

1. An authentication computer comprising a processor, a memory and an interface:
wherein the authentication computer is coupled to plural client computers via a network;
wherein the memory memorizes an user information which includes a correspondence relation between an user and an e-mail address of the user;
wherein the processor receives an authentication demand from the client computer;
wherein the processor allocates, to the received authentication demand, an e-mail address which hasn't been allocated to any authentication demand among the e-mail addresses for the authentication computer to receive an e-mail;
wherein the processor receives an e-mail;
wherein the processor receives an authentication result demand from the client computer;
wherein the processor specifies the authentication demand corresponded to the received authentication result demand;
wherein the processor specifies a source e-mail address from the e-mail whose destination e-mail address is the e-mail address allocated to the specified authentication demand;
wherein the processor refers to the user information to specify the user corresponded to the specified source e-mail address; and
wherein the processor sends data corresponded to the specified user to the client computer which sent the received authentication result demand.

2. An authentication computer comprising a processor, a memory and an interface:
wherein the authentication computer is coupled to plural client computers via a first network;
wherein the authentication computer is coupled to plural e-mail sending computers via a second network;
wherein the memory memorizes an user information which includes a correspondence relation between an user and an e-mail address of the user;
wherein the processor receives an authentication demand which include an identifier of the client computer from the client computer via the first network;
wherein the processor allocates, to an identifier of the client computer included in the received authentication demand, an e-mail address which hasn't been allocated to any authentication demand among the e-mail addresses for the authentication computer to receive an e-mail;
wherein the processor receives an e-mail from the e-mail sending computer via the second network;
wherein the processor specifies a destination e-mail address and a source e-mail address from the received e-mail;
wherein the processor refers to the user information to specify the user corresponded to the specified source e-mail address;
wherein the processor specifies an identifier of client computer which has been allocated the specified destination e-mail address; and
wherein the processor sends data corresponded to the specified user to the client computer identified by the specified identifier via the first network.

3. An authentication computer comprising a processor, a memory and an interface:
wherein the authentication computer is coupled to plural client computers via a first network;
wherein the authentication computer is coupled to plural e-mail sending computers via a second network;
wherein the memory memorizes an user information which includes a correspondence relation between an user and an e-mail address of the user and an authentication e-mail address mapping information which includes a correspondence relation between an client computer and an e-mail address which has been allocated to the client computer not to overlap other client computer among the e-mail addresses for the authentication computer to receive an e-mail;
wherein the processor receives an e-mail from the e-mail sending computer via the second network;
wherein the processor specifies a destination e-mail address and a source e-mail address from the received e-mail;
wherein the processor refers to the user information to specify the user corresponded to the specified source e-mail address;
wherein the processor refers to the authentication e-mail address mapping information to specify the client computer allocated the specified destination e-mail address; and
wherein the processor sends data corresponded to the specified user to the specified client computer via the first network.

4. The authentication computer according to claim 1,
wherein the processor cancels the allocation of the e-mail address in the case that a fixed time passes after the e-mail address is allocated; and
wherein the processor allocates the cancelled e-mail address to allocate once again.

5-25. (canceled)

26. The authentication computer according to claim 2,
wherein the processor cancels the allocation of the e-mail address in the case that a fixed time passes after the e-mail address is allocated; and
wherein the processor allocates the cancelled e-mail address to allocate once again.

27. The authentication computer according to claim 1,
wherein the memory memorizes an authentication e-mail address mapping information which includes a correspondence relation between the received authentication demand and the e-mail address which has been allocated to the authentication demand; and
wherein the processor refers to the authentication e-mail address mapping information to specify the e-mail address allocated to the specified authentication demand.

28. The authentication computer according to claim 1,
wherein the processor gives an identifier to the received authentication demand; and
wherein the processor specifies the authentication demand corresponded to the received authentication result demand based on the identifier included in the received authentication result demand.

29. The authentication computer according to claim 28, wherein the identifier is an identifier of communication between the client computer and the authentication computer or all or a part of the e-mail address allocated to the authentication demand which is given the identifier.

30. The authentication computer according to claim 1,
wherein the processor refers to the user information; and
wherein the processor, in the case that the processor is unable to specify the user corresponded to the specified source e-mail address, judges for the client computer which sent the received authentication result demand to authenticate impossible.

31. The authentication computer according to claim 1,
wherein the processor refers to the user information; and
wherein the processor, in the case that the processor is unable to specify the user corresponded to the specified source e-mail address, memorizes the specified source e-mail address in the user information as an e-mail address of a new user.

32. The authentication computer according to claim 1,
wherein the authentication computer is coupled to an e-mail sending computer; and
wherein the processor receives the e-mail from the client computer or the e-mail sending computer.

33. The authentication computer according to claim 1,
wherein the user information includes a correspondence relation between an user and peculiar information of the user moreover;
wherein the processor refers to the user information to specify the peculiar information correspondence to the specified user;
wherein the processor receives the peculiar information of user from the client computer; and
wherein the processor, in the case that the specified peculiar information and the received peculiar information is identical, judges for the client computer which sent the received authentication result demand to authenticate possible.

34. The authentication computer according to claim 1,
wherein the processor generates new e-mail address for the authentication computer to receive an e-mail, when the processor receives the authentication demand; and
wherein the processor allocates the generated new e-mail address to the received authentication demand to allocate to the received authentication demand an e-mail address which hasn't been allocated to any authentication demand among the e-mail addresses for the authentication computer to receive an e-mail.

35. The authentication computer according to claim 34, wherein the processor cancel allocation of the generated e-mail address by being invalid the generated e-mail address in the case that a fixed time passes after the e-mail address is newly generated.

36. The authentication computer according to claim 1,
wherein the processor judges whether the specified source e-mail address is camouflaged or not; and
wherein the processor judges for the client computer which sent the received authentication result demand to authenticate impossible in the case that the specified source e-mail address is camouflaged.

37. The authentication computer according to claim 3,
wherein the processor cancels the allocation of the user agent address in the case that a fixed time passes after the user agent address is allocated; and
wherein the processor allocates the cancelled user agent address to allocate once again.

38. The authentication computer according to claim 3,
wherein the memory memorizes an authentication user agent address mapping information which includes a correspondence relation between the received authentication demand and the user agent address which has been allocated to the authentication demand; and
wherein the processor refers to the authentication user agent address mapping information to specify the user agent address allocated to the specified authentication demand.

39. The authentication computer according to claim 3,
wherein the processor gives an identifier to the received authentication demand; and
wherein the processor specifies the authentication demand corresponded to the received authentication result demand based on the identifier included in the received authentication result demand.

40. The authentication computer according to claim 39, wherein the identifier is an identifier of communication between the client computer and the authentication computer or all or a part of the user agent address allocated to the authentication demand which is given the identifier.

41. The authentication computer according to claim 3,
wherein the authentication computer is coupled to an signaling sending computer; and
wherein the processor receives the signaling from the client computer or the signaling sending computer.
